(19) United States
(12) Patent Application Publication
(10) Pub. No.: US 2011/0208662 A1
(43) Pub. Date: Aug. 25, 2011

(54) Systems and Methods for Regulatory Compliance

(75) Inventor: Gregory D. Haunschild, Houston, TX (US)

(73) Assignee: ARGENT CONSULTING SERVICES, INC., Houston, TX (US)

(21) Appl. No.: 12/893,754

(22) Filed: Sep. 29, 2010

Related U.S. Application Data
(60) Provisional application No. 61/306,273, filed on Feb. 19, 2010.

(51) Int. Cl. G06Q 10/00

(52) U.S. Cl. 705/317

(57) ABSTRACT

Systems, methods, and computer-readable media for facilitating regulatory compliance are disclosed. A regulatory compliance system includes a regulation module and one or more compliance modules. The regulation module stores regulatory data relating to one or more regulations and subscription data partitioned into to one or more subscriptions. Each of the subscriptions is associated with a client entity and each of the subscriptions is linked to a corresponding portion of the regulatory data relating to at least one of the regulations: The subscription data and the regulatory data are accessible through the one or more compliance modules. Each compliance module is associated with a client entity and provides access to a subscription associated with the client entity and the corresponding portion of the regulatory data to which the subscription is linked. The corresponding portion of the regulatory data may additionally be stored in the compliance module associated with the client entity.

### CROSS-REFERENCE TO RELATED APPLICATIONS

This application claims priority to U.S. Provisional Application Ser. No. 61/306,273 filed on Feb. 19, 2010, the disclosure of which is hereby incorporated in its entirety.

### BACKGROUND

Regulation may be broadly described as the control of human or societal behavior through rides or restrictions. All forms of industry are subject to a variety of forms of regulation from an assortment of regulatory bodies. Industry actors, which may range from large multi-nationals with numerous divisions to local companies or operations, are often required to comply with a myriad of rules and regulations promulgated by various international, national, state and local governmental bodies. In addition, a particular industry may issue its own internal guidelines and industry standards that impose additional Obligations on industry actors. Still further, other non-governmental organizations may impose additional restrictions of requirements on industry actors and industrial activities. A single organization (for example a multi-national corporation) may include numerous subsidiaries or divisions that engage in operations that touch upon a variety of fields of industry, and as such, the organization may he required to comply with several different types and categories of regulations. In addition to the sheer volume of regulations with which an organization may need to ensure compliance, difficulties in ensuring compliance can be compounded by the fact that existing regulations are often modified or deleted and new regulations are periodically promulgated. Tracking changes to regulations is a cumbersome process and systems and methods for efficiently tracking such changes are needed. Failure to keep apprised of changes to regulations that impact one's business or industry can lead to severe consequences such as revocation of permits, loss of revenue, and potentially, complete business failure.

The present invention relates to systems, methods, and computer-readable media for regulatory compliance. More specifically, the present invention relates to systems, methods, and computer-readable media for facilitating efficient regulatory compliance.

### SUMMARY

In accordance with one or more embodiments of the invention, a regulatory compliance system comprises: a regulation module and one or more compliance modules. The regulation module comprises: regulatory data relating to one or more regulations, and subscription data partitioned into one or more subscriptions, each of the subscriptions being associated with a client entity and being linked to a corresponding portion or the regulatory data relating to at least one of the regulations. The subscription data and the corresponding regulatory data is accessible through the one or more compliance modules, each compliance module being associated with a client entity and providing access to a subscription and the corresponding portion of the regulatory data associated with the client entity.

In accordance with one or more embodiments of the invention, access to the regulation module may be restricted to one or more regulation module users, and for each of the compliance modules, access to the compliance module may be restricted to one or more compliance module users designated by the client entity associated with the compliance module. The regulation module may comprise: one or more data storage devices storing the regulatory data and the subscription data, and each of the compliance modules may comprise one or more data storage devices storing compliance data, the compliance data being linked to the regulatory data that is linked to the subscription associated with the client entity that is associated with the compliance module.

In one or more embodiments of the invention, the regulatory data corresponding to the subscription associated with the client entity and to which the compliance data is linked may be stored in the compliance module. In other embodiments, the compliance data may be linked to corresponding regulatory data stored in the regulation module.

In accordance with one Or more embodiments of the invention, a method for regulatory compliance is disclosed. The method comprises: inputting and storing regulatory data relating to one or more regulations on one or more data storage devices; generating subscription data, the subscription data being stored on the one or more data storage devices and being partitioned into one or more subscriptions, each of the subscriptions being associated with a client entity and being linked to a corresponding portion of the regulatory data relating to at least one of the regulations; and providing each client entity with access to an associated subscription and the corresponding portion of the regulatory data through an associated compliance module.

In accordance with one or more embodiments of the invention, a computer-readable medium storing a computer program for regulatory compliance is disclosed. The computer program comprises instructions for: generating subscription data, the subscription data being stored on one or more data storage devices and being partitioned into one or more subscriptions, each of the subscriptions being associated with a client entity and being linked to a corresponding portion of regulatory data relating to at least one of or more regulations, the regulatory data being stored on the one or more data storage devices; and providing each client entity with access to an associated subscription and the corresponding portion of the regulatory data through an associated compliance module.

These and additional embodiments of the invention will be described in further detail in the detailed description that follows through reference to the following drawings.

### BRIEF DESCRIPTION OF DRAWINGS

FIG. 1A is a depiction of regulation module functionality for searching and browsing regulations in accordance with one or more embodiments of the invention.

FIG. 1B is a depiction of regulation module functionality for searching and browsing regulations in accordance with one or more additional embodiments of the invention.

FIG. 1C is a depiction of regulation module functionality for accessing and displaying a history of versions of regulatory data relating to one or more regulations in accordance with one or more embodiments of the invention.

FIGS. 2A-2B are a depiction, of regulation module functionality for editing regulatory data in accordance with one or more embodiments of the invention.

FIGS. 3A-3B are a depiction of regulation module functionality for storing new regulatory data in the regulation module in accordance with one or more embodiments of the invention.

FIG. 4A is a depiction of regulation module functionality for displaying and accessing subscription data in accordance with one or more embodiments of the invention.

FIG. 4B is a depiction of regulation Module functionality for displaying information relating to a subscription in accordance with one or more embodiments of the invention.

FIG. 4C is a depiction of regulation module functionality for displaying and modifying client entity identifying information.

FIG. 5A is a depiction of regulation module functionality for displaying and editing regulatory data relating to regulation categories in accordance with one or more embodiments of the invention.

FIG. 5B is a depiction of regulation module functionality for displaying and editing regulatory data relating to regulation types in accordance with one or more embodiments of the invention.

FIG. 6A is a depiction of regulation module functionality for managing regulatory data tables in accordance with one or more embodiments the invention.

FIG. 6B is a depiction of regulation module functionality for managing regulatory data table types in accordance with one or more embodiments of the invention.

FIG. 7 is a schematic depiction of the architecture of a regulatory compliance system in accordance with one or more embodiments of the invention.

FIG. 8 is a depiction of compliance module functionality for viewing modifications to regulatory data in accordance, with one or more embodiments of the invention.

FIG. 9 is a depiction of compliance module functionality for identifying modified regulatory data in accordance with one or more embodiments of the invention.

FIG. 10 is a depiction of compliance module functionality for assessing an impact of modifications to regulatory data in accordance with one or more embodiments of the invention.

FIG. 11 is a depiction of compliance module functionality for determining applicability of a regulation in accordance with one or more embodiments of the invention.

FIGS. 12A-1213 are a depiction of compliance module functionality for managing regulatory data relating to regulations applied to a site in accordance with one or more embodiments of the invention.

FIG. 13 is a depiction of compliance module functionality for displaying and managing site regulatory compliance in accordance with one or more embodiments of the invention.

FIG. 14 is a depiction of compliance module functionality for displaying and managing company regulatory compliance in accordance with one or more embodiments of the invention.

FIG. 15 is a depiction of compliance module functionality for displaying and managing responsible person regulatory compliance in accordance with one or more embodiments of the invention.

FIG. 16 depicts a flowchart illustrating a method for facilitating regulatory compliance in accordance with one or More embodiments of the invention.

### DETAILED DESCRIPTION

As will be appreciated by one of ordinary skill in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable media may be utilized. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage media would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain or store a program for use by or in connection with an instruction execution system, apparatus, or device. Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including, but not limited to, an object oriented programming language such as Java, Smalltalk, C++ or the like, a common language infrastructure (CLI) language such as C#, C++/CLI, F#, J#, #Smalltalk, or any other CLI implementation of another programming language, and “conventional” procedural programming, languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention may be described below with reference to figures that may depict web pages that are accessible as part of a web-based system. The web pages may be programmed using any appropriate programming language and may be stored along with any data accessible through the web pages on one or more servers. Alternately, the web pages may be hosted on servers different from those servers that store the data accessible through the web pages. The web pages and data may be accessible using a client-server computing model or any other computing model known to one of ordinary skill in the art.

Aspects of the present invention may be described below with reference to flowchart illustrations and/or block diagrams of methods, apparatuses (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions May also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks. The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

A regulatory compliance system in accordance with one or more embodiments of the invention may comprise a regulation module and one or more compliance modules. The system may be a web-based system or a networked system of any kind that allows users of the one or more compliance modules to access and retrieve data that may be stored in the regulation module and that allows for the transfer of data between the regulation module and the one or more compliance modules.

The system may be provided as part of or in connection with a service for assisting clients with regulatory compliance. The clients may include any entity that desires an efficient and effective means for ensuring regulatory compliance. For example, the clients may include large organizations with several offices or sites nationally and/or internationally, or smaller organizations that consist of a single location or site. The offices, locations, or sites may correspond to manufacturing plants, headquarters or other office locations, satellite locations, etc. The clients maybe governmental entities, non-governmental entities, or private enterprises.

In accordance with one or more embodiments of the invention, the regulation module may store regulatory data and subscription data. The regulatory data may relate to one or more regulations and the subscription data may be partitioned into one or more subscriptions. Each of the subscriptions may be associated with a client entity and may be linked to a corresponding portion of the regulatory data. The portion of the regulatory data that a subscription links to may comprise data relating to at least one regulation. It should be noted that the term “portion” as used herein shall connote a part or a whole of something.

Access to the regulation module may be restricted to certain regulation module users. The regulation module users may be assigned hierarchical access to the regulation module with certain regulation module users being provided with access to increased functionality as compared to other users. Restricted access may be implemented by providing a log-in web page that authenticates a user based on an entered username and password. Similarly, access to each of the compliance modules may be restricted to certain compliance module users designated by the client entity that is associated with the subscription that is accessible through the compliance module. The structure, design, and function of the compliance modules will be described in greater detail hereinafter.

In one or more embodiments of the invention, the regulation module may comprise one or more data storage devices that store the regulatory data and the subscription data. The regulatory data and/or the subscription data may be accessed, retrieved, displayed, and potentially copied to the one or more compliance modules. The compliance module users may be provided with the functionality to modify at least a portion of the regulatory data and/or subscription data that is locally stored on the compliance modules. The data storage devices may be any known in the art including non-volatile storage devices such as magnetic disk drives, optical disk drives, non-volatile memory devices such as Flash memory or EPROM as well as volatile storage such as various types of RAM including SRAM, DRAM, DDR SDRAM, etc. The data storage devices may comprise one or more databases which may be relational databases or databases having any other suitable database format or architecture.

The regulatory data may comprise information that relates, for example, to a variety of rules and regulations promulgated by governmental entities and/or guidelines or standards issued by industry standards associations or organizations. The regulatory data may additionally relate to internal policy standards or guidelines specific to one or more organizations or companies. In one or more embodiments of the invention, the regulatory data may relate to a variety of environmental and safety related regulations promulgated by various levels of government. In the context of the United States, the regulatory data may relate, for example, to statutes passed by the federal legislative body (U.S. Congress), regulations promulgated by federal agencies such as the Environmental Protection Agency (EPA). Occupational Health and Safety Administration (OSHA) and other federal agencies, laws passed by state legislative bodies, regulations promulgated by state agencies, ordinances passed by state and local governments, and so on. The term “regulation” as used herein refers to any statute, law, regulation, rule, guideline, or requirement of any kind passed or promulgated by any entity, governmental or non-governmental, within any jurisdiction, foreign or domestic.

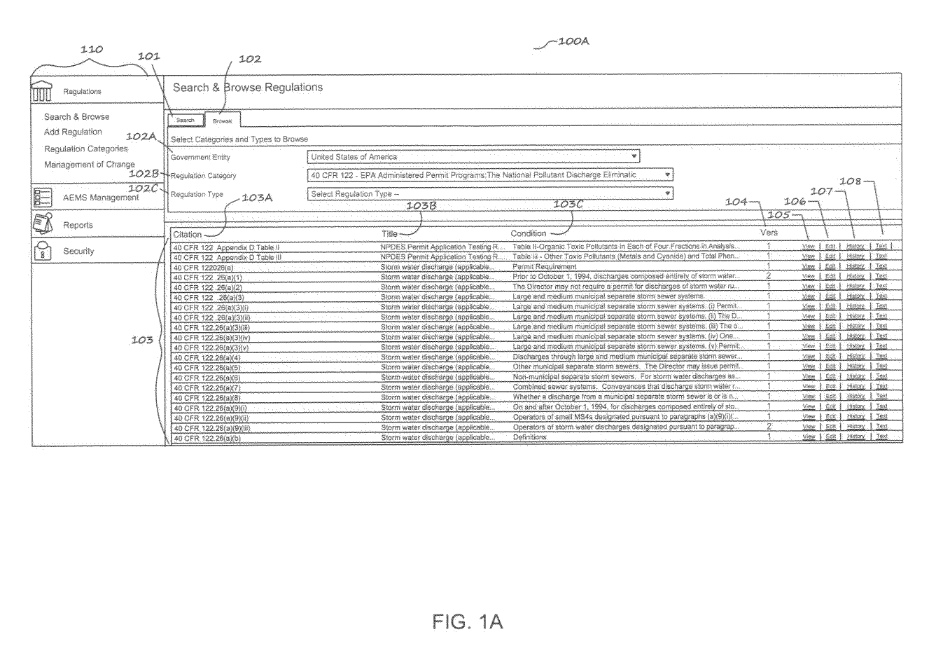

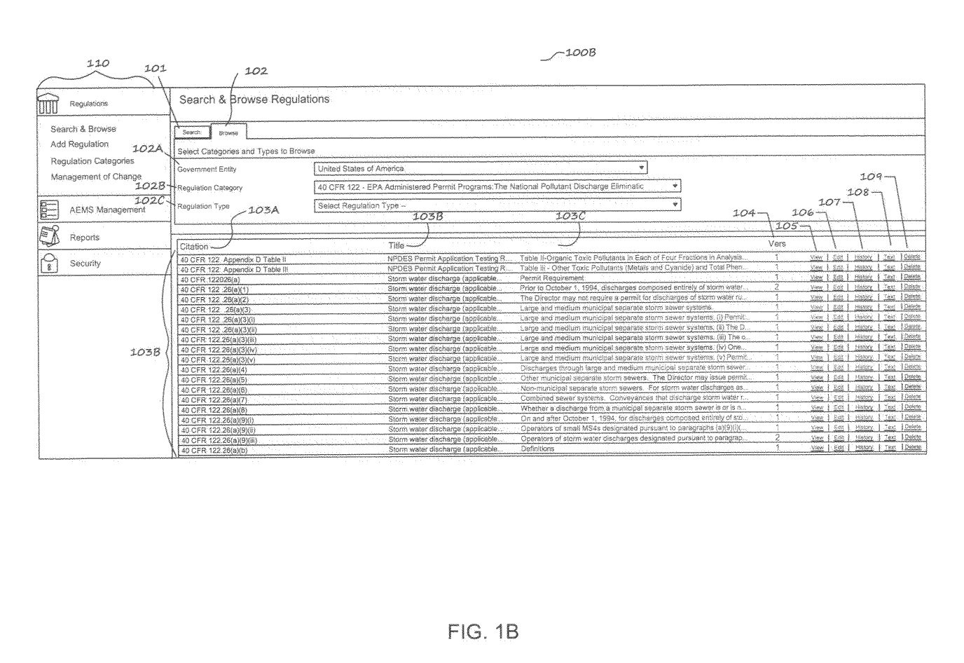

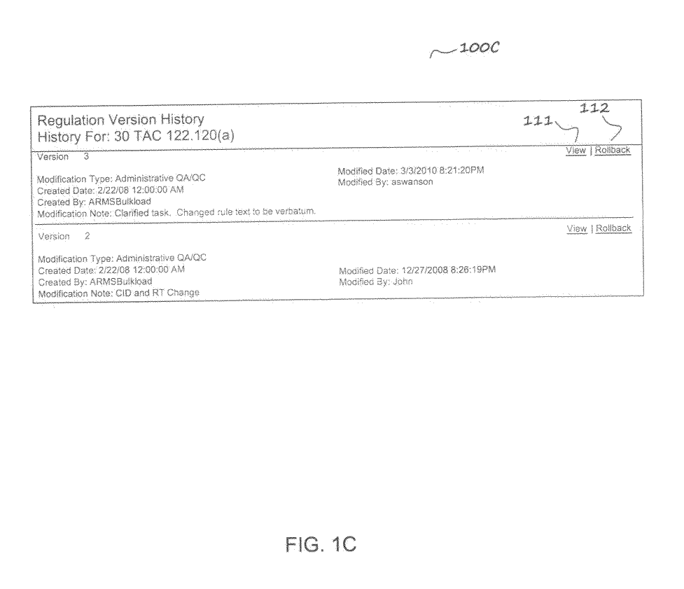

FIG. 1A provides a depiction of regulation module functionality for searching and browsing regulations in accordance with one or more embodiments of the invention. Upon being authenticated as a valid regulation module user, the user may be directed to a web page 100 that allows the user to search for 101 and browse 102 regulatory data stored on the one or more data storage devices of the regulation module. Through the search function 101, a regulation module user may retrieve regulatory data based on one or more search criteria. For example, a regulation module user may enter a string of keywords in order to locate regulatory data relating to one or more regulations. Various searching algorithms may be available to the user such as free-form search, Boolean search, etc.

Alternatively, a regulation module user is provided with a browse function 102 that allows the user to retrieve a listing 103 of regulatory data relating to one or more regulations based on one or more user-selected regulation identifiers. For example, drop-down fields may be provided for selecting various filtering criteria. The filtering criteria may comprise a governmental entity 102A, a regulation category 102B, and a regulation type 102C. It should be noted that additional or alternate filtering criteria may be provided and that embodiments of the invention are not limited to the particular interface shown in FIG. 1A for selecting the filtering criteria and presenting the information to the user.

A governmental entity refers to the particular entity or agency that passed or promulgated the regulation of interest. The term “governmental entity” encompasses both governmental and non-governmental entities. A regulation category refers, generally, to a grouping of related regulations. For example; a regulation category may refer to a grouping of regulations that pertain to safety standards for a chemical plant that processes or produces hazardous chemicals. A regulation type may be a subset of a regulation category. For example, a regulation type may refer to a specific subset of regulations that form part of a regulation category.

A regulation module user may select values for each of the fields mentioned above. A request is then sent to the regulation module to retrieve, from the one or more data storage devices, regulatory data relating to one or more regulations that meet the filtering criteria. The regulatory data is presented to the user via listing 103. The regulatory data displayed with respect to each regulation returned in the listing 103 may include, for example, the regulation citation 103A (i.e., the identifier used to identify and locate the regulation), a title assigned to the regulation 103B, the actual or paraphrased version of the text of the regulation (also referred to as the condition) 103C, and an indication 104 of the number of versions of a regulation.

The version indicator 104 may provide information regarding the number of revisions that have been made to the regulatory data associated with a particular regulation. For example, if the text of a regulation has been altered through a legislative enactment, the regulatory data stored in the regulation module that relates to the regulation will be modified to reflect the change to the text. The version indicator 104 will then be updated to reflect the multiple versions of the regulatory data relating to the modified regulation. If the modification to the text is the first change that has been made to the regulatory data pertaining to that regulation, then the version indicator 104 will display a “2” in connection with the regulation to indicate that two versions of the regulatory data exist for that regulation. Functionality may be provided to the regulation module user that allows the user to view a history 107 of the versions (iterations) of the regulatory data relating to each regulation.

Additional functionality provided to the regulation module user may include the ability to view 105 the regulatory data relating to a regulation, edit 106 the regulatory data relating to a regulation, and view only the text 108 of the regulation. Various other categories of information included in the regulatory data relating to each regulation will be described in greater detail hereinafter.

FIG. 1C depicts regulation module functionality that provides a regulation module user with the capability to view a history of versions of regulatory data relating to a regulation. This functionality may be made available to a user by means of, for example, a “Regulation Version History” web page that the user is directed to upon selection of the option to view the history 107 of a regulation from the “Search and Browse Regulations” web page 100A or 100B.

The web page 1000 may provide information relating to each version of the regulatory data relating to a regulation. The information may include the type of modification to the regulatory data that was made that resulted in the new version, the party responsible for the modification, and a note describing the modification. The user may be provided with the option of viewing 111 each version of the regulatory data. In addition, the user may be provided with functionality to “rollback” 112 the regulatory data to a previous version of the data. For example, if a user meets the appropriate access requirements, he/she may be provided with the capability to reverse certain changes to the regulatory data in order to revert back to an original version of the regulatory data.

FIG. 1B depicts regulation module functionality for searching and browsing regulatory data in accordance with one or more additional embodiments of the invention. The web page 100B depicts a specific embodiment of the invention in which the government entity 102A and the regulation category 102b have been specified as “Obsolete Rules.” As such, the listing of regulatory data 103B retrieved from the regulation module and displayed in web page 100B relates to those regulations that have been deemed obsolete.

One or more regulation module users may be provided with the authorization to designate a particular regulation as obsolete. If for example, a legislative body has repealed a particular regulation stored in the regulation module, a regulation module user having the appropriate level of access may designate the regulation as obsolete, which in turn may result in an alternate categorization Of the regulatory data relating to the regulation within the one or more data storage devices of the regulation module. In connection with the listing 103B of regulatory data relating to obsolete regulations, a regulation module user may be provided with additional functionality that allows the user to delete 109 the regulatory data relating to a particular obsolete regulation. Appropriate security measures may be taken to ensure that a regulation is not misidentified as obsolete and that the regulatory data relating to the regulation is not improperly deleted from the regulation module.

Referring again to FIGS. 1A and 1B, a regulation module user may be provided with the option to edit 105 the regulatory data relating to a particular regulation. The edit function 105 may be selected by, for example, clicking on a hyperlink that directs the user to a web page that displays the regulatory data relevant to the selected regulation.

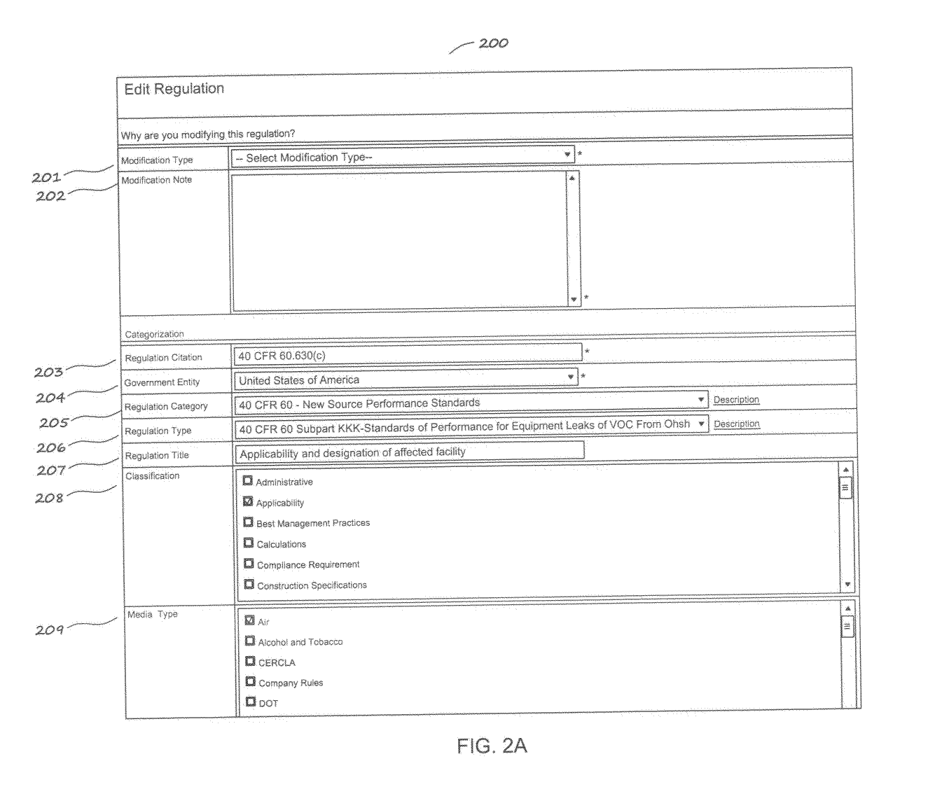

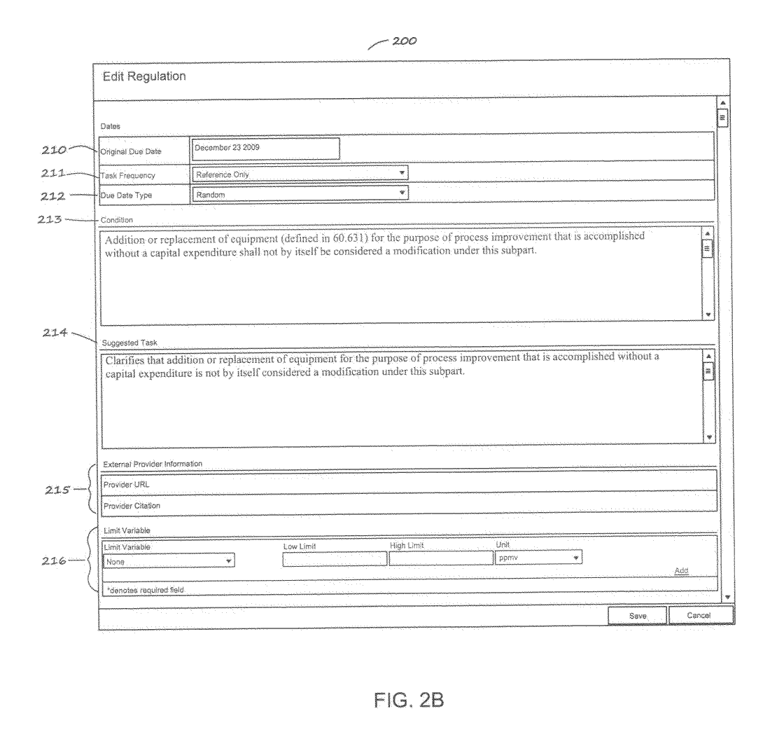

FIGS. 2A-2B depict regulation module functionality in accordance with one or more embodiments of the invention, for editing regulatory data relating to a particular regulation. As shown in FIGS. 2A-2B, the regulation module functionality for editing regulatory data relating to a regulation may be provided, by means of an “Edit Regulation” web page 200.

The regulatory data associated with a regulation may include various fields or categories of information relating to the regulation. These fields or categories of information may be referred to herein as regulatory data sub-types or simply data sub-types. These data sub-types may be edited or modified by a regulation module user having the appropriate level of access. The data sub-types that form part of the regulatory data associated with a regulation may comprise, but are not limited to, modification data, categorization data, classification data, date data, permit data, text data, and task data. It should be noted that the data sub-types are not limited to the particular ones listed above and that other data sub-types are within the scope of the invention. It should also be noted that one or more of the data sub-types may not be present in certain embodiments. The types of data included in each of these data sub-types which will be described in greater detail hereinafter. Although reference may be made to specific user interfaces and particular web page designs throughout this disclosure, one of ordinary skill in the art will appreciate that many variations in user interfaces, web page designs, and presentation to a user of the functionality of regulatory compliance systems according to embodiments of the invention are within the scope of this disclosure.

The modification data may include data relating to a type of modification being made 201 and a note relating to the modification 202. The modification type 201 may be a modification that relates to any of the data sub-types associated with the regulation. For example, the modification type may indicate a modification to the text of the regulation, a modification to the suggested task associated with the regulation, or a modification to the frequency with which the task should be completed. In one or more embodiments of the invention, a drop-down menu may be provided for selecting the modification type 201 from a listing of modification types. Although reference is made to drop-down menus, the particular manner in which content is displayed to a user and manipulable by a user is not

A field may be provided for inputting a modification note 202 which allows a regulation module user to describe in detail aspects and effects of the modification being made. As such, the user may inform other regulation module users and/or compliance module users of the basis for a particular modification.

The categorization data includes data providing identifying information pertaining to the regulation. Fields may be provided for identifying information which may comprise data relating to a regulation citation 203, a government entity 204, a regulation category 205, a regulation type 206, and a regulation title 207.

The regulation citation 203 is an identifier created by the body that promulgated the regulation that is used to refer to or locate the regulation. The government entity 204 identifies the particular entity that promulgated the regulation. Although the term government entity is used here, it should be noted that non-governmental organizations may also be identified. As described earlier, the regulation category 205 specifies the particular grouping or set of related regulations of which the regulation is a part, and the regulation type 206 identities a subset of regulations to which the regulation belongs, the subset being contained within the set of regulations that form the regulation category. The regulation title 207 may be a title given to the regulation by the entity that promulgated the regulation or a descriptor selected by a regulation module user.

The classification data may include a classification data sub-type 208 that provides a broad overview of a type of the regulation. A user may select from a listing of types of regulations. The selectable types included in the classification data sub-type 208 may include administrative, applicability, compliance requirement; best management practices, calculations, constriction specifications, control, requirements, definitions, emission limits, and so on. For example, if a particular regulation is directed to limits placed on the emission of a particular chemical during a manufacturing process, the regulation may be broadly classified as an emission limit regulation. Alternately, if the regulation deals with certain measures that must be taken or standards that must be met by a company as it pertains to its particular operations, the regulation module user may select “compliance requirement” as the classification data sub-type 209.

The classification data further includes media type data 209 that specifies a particular medium or media to which the regulation applies. For example, if the regulation is directed to air quality control, the media type may be selected as air. Alternatively, if the regulation deals with worker safety, the safety media type may be selected. A regulation may affect more than one medium, in which case the media type data may include multiple media types.

Referring now to FIG. 2B, the “Edit Regulation” web page 200 may additionally include data sub-types relating to various dates relevant to the regulation. For example, data sub-type 210 that relates to a due date for performing a task mandated by the regulation may be specified. In addition, data sub-type 211 that relates to a task frequency may be selected. Data sub-type 211 may specify a frequency with which a task required to comply with the regulation must be performed. For example, if the regulation is a compliance requirement that requires a manufacturing plant to perform periodic quality control assessments, the task frequency data sub-type 211 may specify the frequency with which such quality control assessments must be performed.

In accordance with one or more embodiments of the invention, task frequency reminders relating to a particular regulation may be sent to each compliance module that is associated with a client entity which is in turn associated with a subscription that is linked to the regulatory data that relates to the regulation. The timing of a task frequency reminder may be automatically determined based on the task frequency. For example, if a task is required to be performed every 5 years, the task frequency reminder may be automatically sent to the compliance module 18 months prior to the task due date. Alternately, the timing of the task frequency reminder for a particular regulation may be dynamically determined based on one or more criteria such as the values of one or more data sub-types relating to the regulation.

In one or more embodiments of the invention, a due date type data sub-type 212 may also be specified. The data sub-type 212 may indicate, for example, that the due date is a recurring date. Alternatively, the data sub-type 212 may indicate that the due date is randomly assigned in embodiments where the regulation does not require the performance of a task by a specific date.

The regulatory data associated with a regulation may further include permit data (not shown) in which details regarding any permits required by the regulation may be specified. The permit data may include permit condition effective date data as well as data relating to a type of permit associated with the regulation.

The data sub-types relating to the regulation may further include text data 213 and task data 214. The text data 213 (also referred to as condition data) represents a description or summary of the regulation. The text data 213 may be the exact text of the regulation or a summary of the text of the regulation. For example, a regulation module user may wish to condense or summarize a complicated regulation to facilitate comprehension of the regulation by compliance module users. The task data 214 may include a short summary or analysis of the effect of the regulation and a suggested course of action for complying with the regulation.

External provider data 215 may also be specified. The external provider data 215 may identify the source from which the regulation may be obtained as well as the provider citation. In addition, limit variable data 216 may also be specified. In, particular, if the regulation requires certain numerical limits with respect to, for example, emissions produced by a plant engaged in a particular manufacturing process, or exposure of workers to certain chemicals, these limits may be specified as the limit variable data 216.

As discussed earlier, a history of the edits made by one or more regulation module users that are provided with the capability to edit regulatory data associated with a regulation may also be maintained. As such, if desired, a previous version of the regulatory data relating to a regulation may be accessed. In this manner, changes made to regulatory data may be tracked.

In addition to editing the regulatory data relating to a regulation that is currently stored on the one or more data storage devices Of the regulation module, a regulation module user meeting the appropriate access requirements may specify and store regulatory data relating to an additional regulation. The additional regulation may be a newly promulgated regulation or an existing regulation for which regulatory data has not been previously stored in the regulation module.

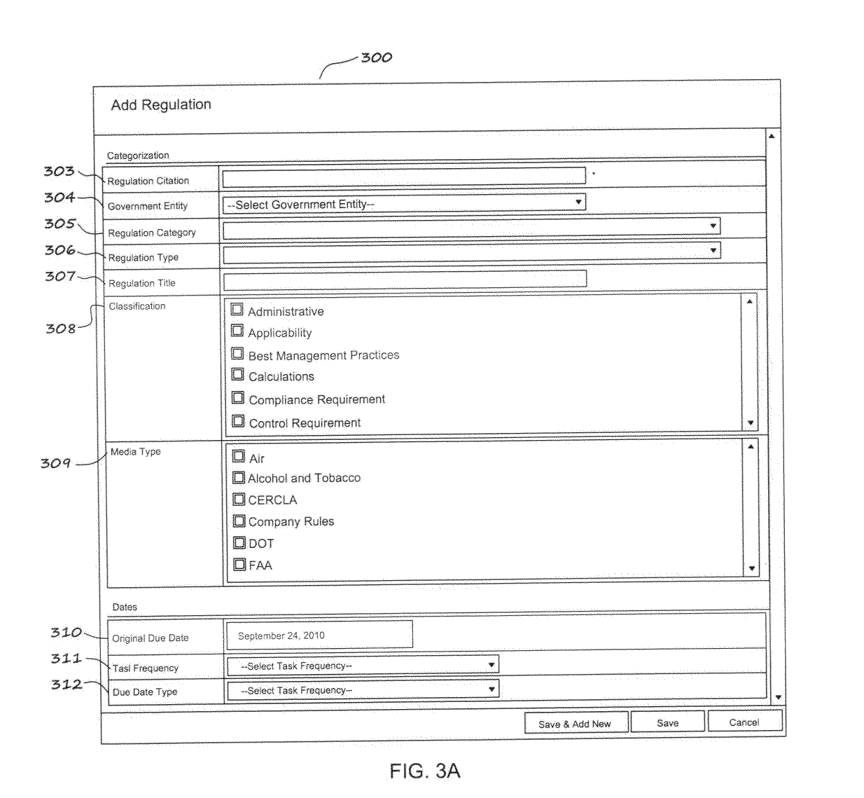

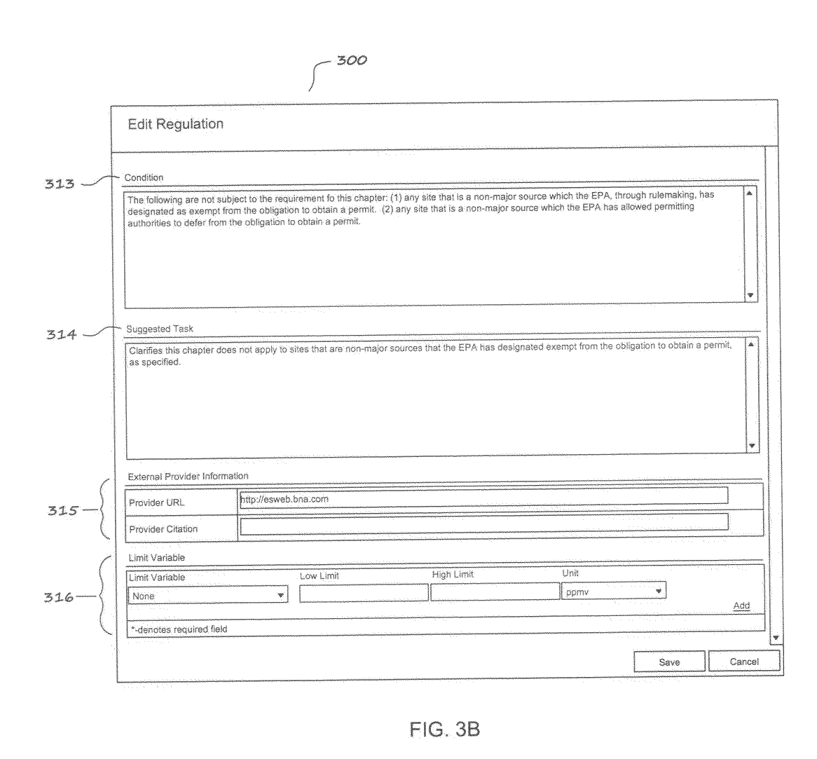

FIGS. 3A-3B depict regulation module functionality for inputting and storing regulatory data relating to an additional regulation in accordance with one or more embodiments of the invention. This functionality may be provided by means of for example, an “Add Regulation” web page 300. Several of the same data sub-types discussed above with respect to FIGS. 2A-2B may also be specified when an additional regulation is first added to the regulation module. For example, data sub-types 303-316 may correspond to data sub-types of 203-216 depicted in FIGS. 2A-2B.

The regulation module may further comprise subscription data. The subscription data may be partitioned into one or more subscriptions. The subscription data may be stored on the one or more data storage devices of the regulation module. Each subscription may be linked to a corresponding portion of the regulatory data that relates to at least one of the regulations. For example, a client entity's subscription may be linked to regulatory data relating to certain regulation categories or types that are pertinent to a client entity's industry or business. In this manner, the client entity is provided with the capability to monitor and track pertinent regulations.

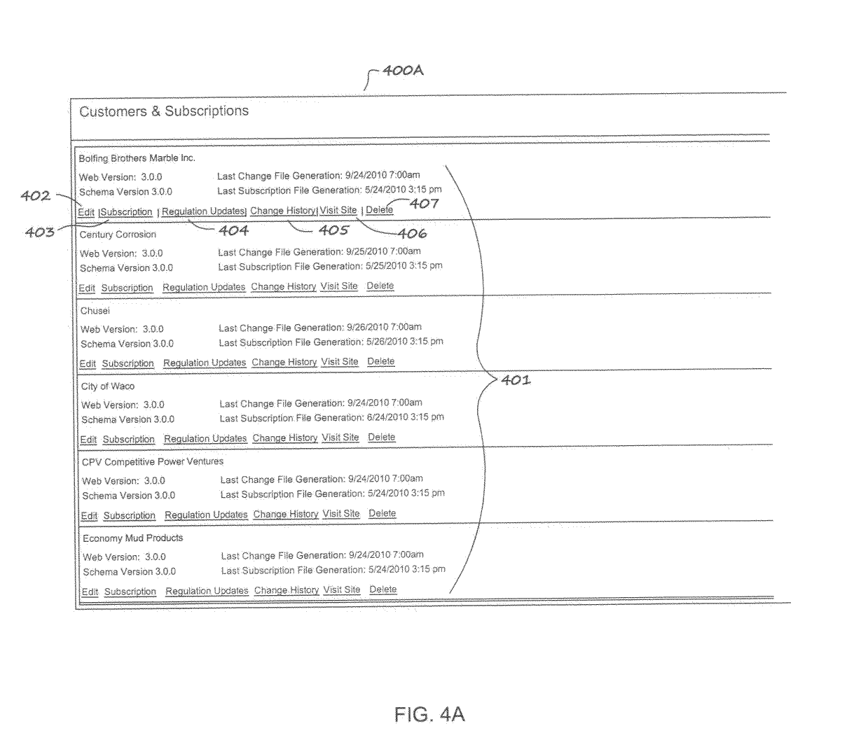

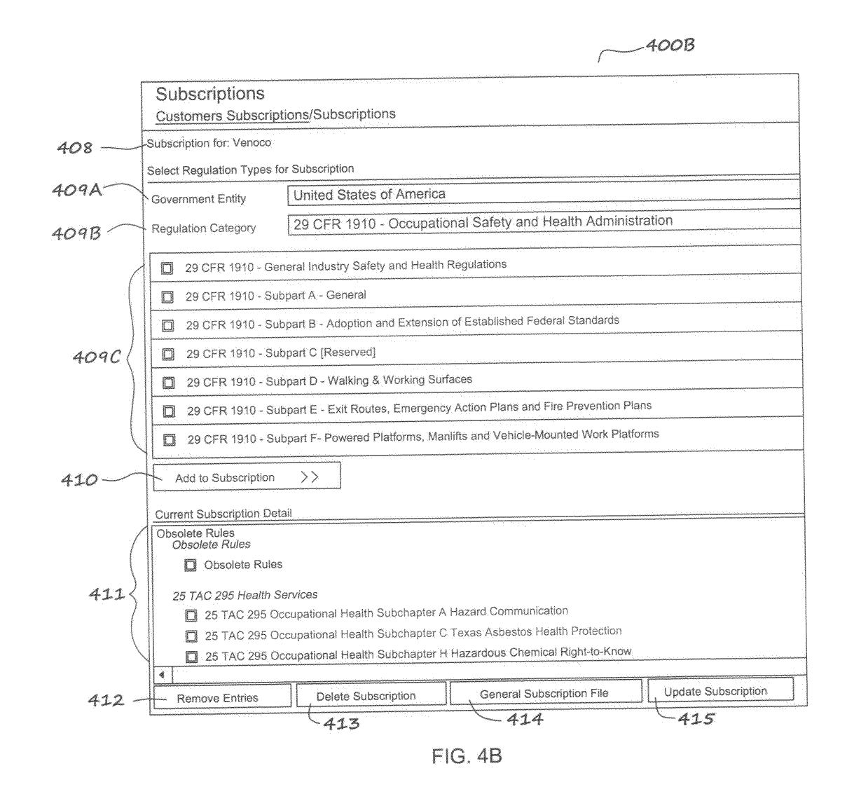

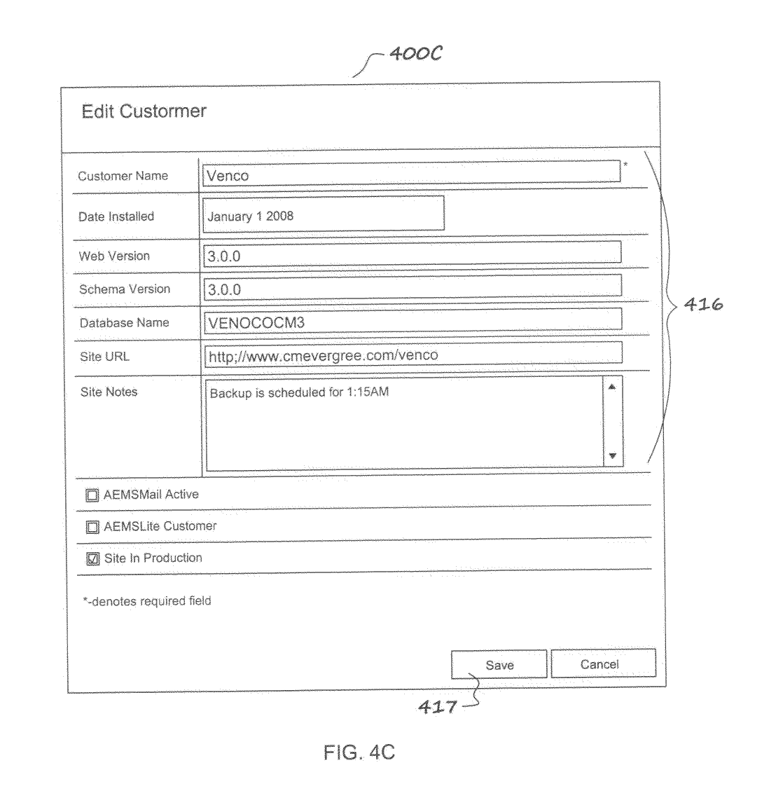

FIGS. 4A-4C depict regulation module functionality for displaying and accessing subscription data in accordance with one or more embodiments of the invention. The regulation module functionality may be implemented through various web pages 400A-400C. Web page 400A shown in FIG. 4A provides a regulation module user with a listing 401 of subscriptions. In one or more exemplary embodiments, a regulation module user is provided with various types of functionality with respect to each subscription. For example, a regulation module user (depending on his/her level of access) may be provided with the capability to edit 402 the subscription, to view 403 details of the subscription, to view and/or manage 404 updates or modifications to the regulatory data to which the subscription is linked, to modify 405 the history of the subscription, to visit 406 a site associated with the client entity that is associated with the subscription, and, potentially, to delete 407 the subscription. Other types of information such as time/date stamps relating to actions taken in connection with a subscription may also be provided to a regulation module user.

Throughout this disclosure, a subscription is referred to as being linked to a corresponding portion of the regulatory data. The portion of the regulatory data that a particular subscription links to includes regulatory data relating to one or more regulations included in the subscription. The portion of the regulatory data that a subscription links to may be stored on data storage devices included in the regulation module and/or on data storage devices included in each compliance module associated with the subscription. For example, the portion of the regulatory data corresponding to a subscription may be transferred or copied to the compliance module(s) that provides access to the subscription in this manner, access, retrieval, and manipulation of regulatory data corresponding to a subscription is made more efficient.

The functionality that allows a user to view 403 details of a subscription may be implemented, for example, by means of a clickable hyperlink which may direct a user to web page 400B shown in FIG. 4B. The web page 400B may display information relating to a particular subscription. The information may include a descriptor 408 that identifies the client entity with whom the subscription is associated. A regulation module user having the appropriate access level may be provided with the options of browsing for additional regulations to include in the client's subscription. It should be noted that including an additional regulation in a subscription is simply an alternate manner of describing the process of linking regulatory data relating to a regulation to a subscription, where the regulatory data was not being previously linked to the subscription. A regulation module user may be provided with the option of selecting various filtering criteria such as a government entity 409A and a regulation category 409B. The government entity 409A, as described earlier, may refer to the entity, governmental or non-governmental, that promulgated the regulation. The regulation category 409B may refer to a particular grouping of related regulations. Upon selecting the filtering criteria, a listing 409C of regulations meeting the filtering criteria is displayed to the user. A regulation module user may then select one or more regulations returned in the listing of regulations 409C to add 410 to the subscription. As described earlier, adding a regulation to a subscription is achieved by linking the regulatory data relating to the regulation to the subscription.

The web page 400B also provides a regulation module user with a listing 411 of the regulations that are currently part of the client entity's subscription. The regulation module user may be provided with various functionality that allows the user to remove 412 regulations from the subscription (equivalent to removing the link between the regulatory data relating to a regulation and the subscription), delete 413 the subscription from the regulation module, generate a subscription file 414, and update a subscription 415. A user may choose to delete 413 a subscription when a client entity no longer desires the real-time regulation monitoring and tracking provided by the regulatory compliance system according to embodiments of the invention. Updating a subscription 415 will ensure that any modifications to the regulatory data that is linked to the subscription are also linked to the subscription.

FIG. 4C depicts regulation module functionality for displaying and modifying client entity identifying information. The functionality may be implemented by means of an “Edit Customer” web page 400C that displays various fields of identifying information 416 relevant to the client. The information fields may include the customer name, the date the customer was entered into the regulation module, the name given to the internal organization of subscription data relating to the customer (database name), the customer's website address, etc. A regulation module user having the appropriate level of access may be able to edit the various information fields and save 417 any modifications that are made.

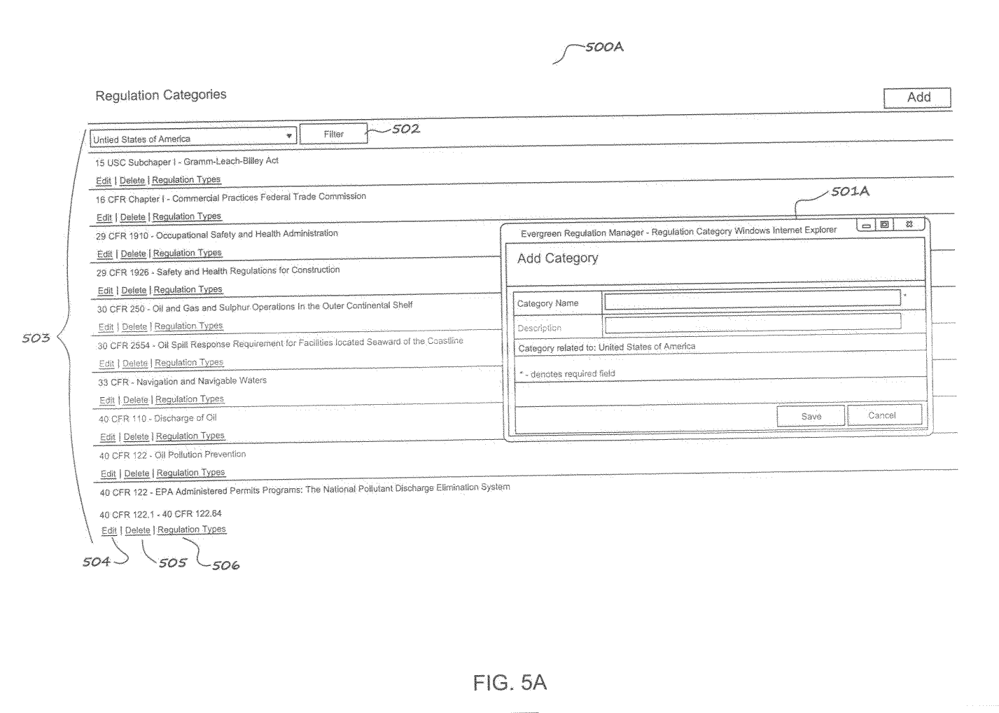

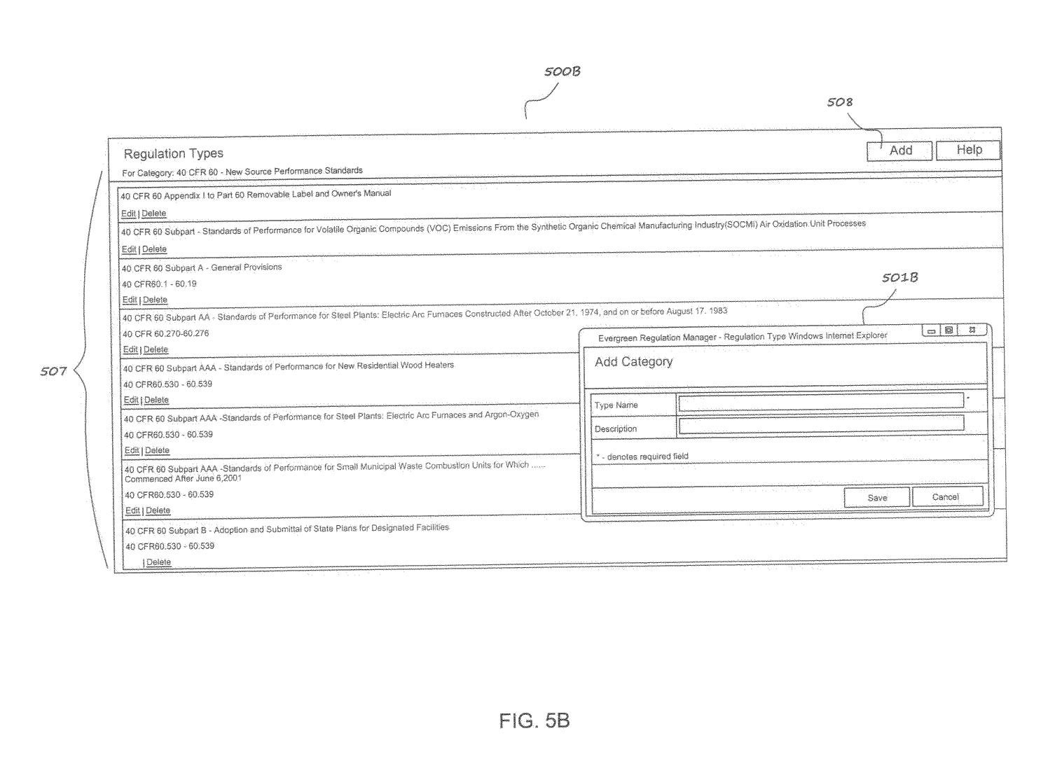

FIG. 5A depicts regulation module functionality for displaying and editing regulatory data relating to regulation categories in accordance with one or more embodiments of the invention. This functionality may be provided to the user by way of the web page 500A shown in FIG. 5A. A regulation module user having the appropriate level of access may be provided with the capability to retrieve a listing 503 of regulation categories based on certain filtering criteria. For example, a regulation module user may select: a particular government entity and filter 502 the regulatory data to retrieve the listing 503 of regulation categories relevant to the selected government entity.

In addition, the regulation module user may be provided with functionality to modify various aspects of one or more regulation categories. For example, a user may be able to edit 504 a regulation category. This functionality may be implemented as shown in FIG. 5A by means of, for example, an “edit” hyperlink that when clicked on generates web page 501A. Through web page 501A, the regulation module user may be able to modify the category name as well as provide or modify a description of the category. Additionally, a regulation module user may be able to delete 505 a regulation category that is no longer required or desired.

A regulation module user may also be provided with functionality to access and edit regulation types. This functionality may be implemented, for example, by means of a “regulation types” hyperlink 506 that where clicked upon may direct a user web page 500B shown in FIG. 5B. In particular, a regulation module user may click on the “regulation types” hyperlink associated with a particular regulation category and be directed to web page 500B that displays a listing 507 of regulation types that are contained within that particular regulation category. A regulation module user may also be provided with functionality to add 508 a new regulation type to the selected regulation category by means of for example, an “add” button. In adding a new regulation type, the regulation module user may be required to specify the regulation type name and provide a description for the regulation type that may be, for example, an indication of the citation range for regulations contained within the regulation type.

In accordance with one or more embodiments of the invention, the regulatory data and/or the subscription data may be stored on one or more data storage devices. The one or more data storage devices may comprise one or more databases. The regulatory data and/or the subscription data may be stored on the one or more databases, which may be, for example, one or more relational databases. The regulatory data and/or the subscription data may be organized in one or more tables that are groupings of data elements organized using a model of vertical columns and horizontal rows. In one or more embodiments, the regulatory data and/or subscription data organized in the one or more tables may be stored externally to the one or more databases. Each table may have a specified number of columns, but an unspecified number of rows and each row in a table may be identified by the values appearing in a particular column subset identified as the candidate key. Each table may be associated or linked with one or more other tables through the candidate key column of each table. The regulatory data relating to the one or more regulations included in a client'subscription maybe linked to the subscription through the candidate keys.

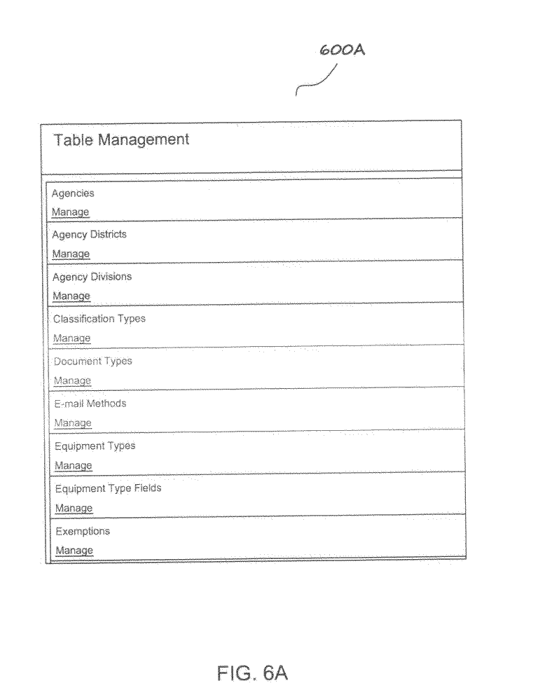

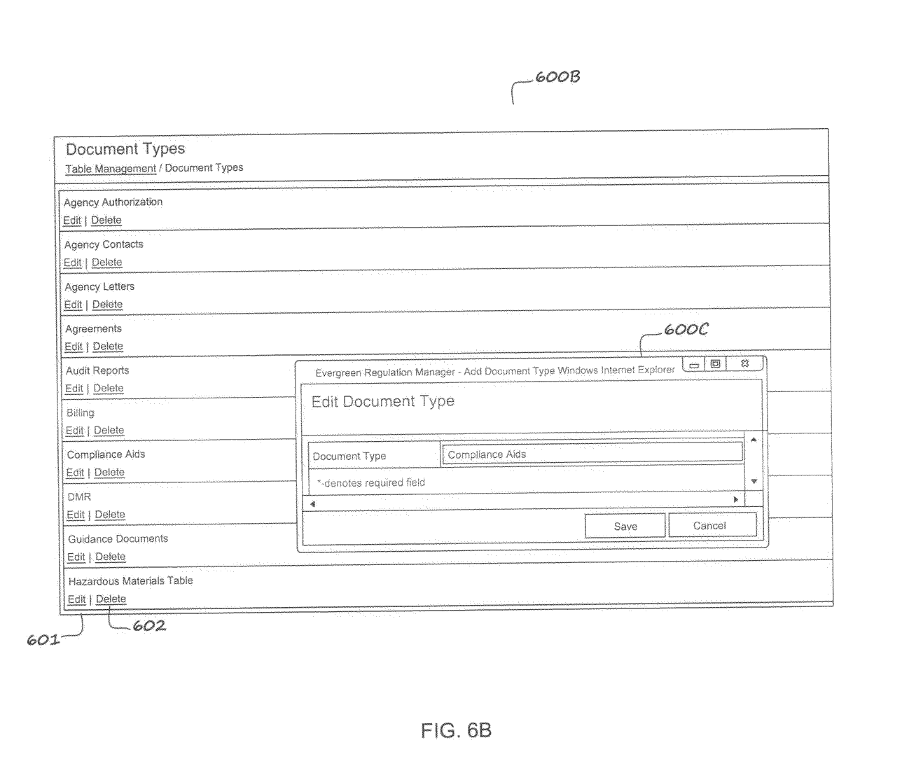

Users of the regulation module having the appropriate level of access may be provided with functionality to manage and/or modify aspects of database tables stored in the regulation module by means of, for example, the “Table Management” web page 600A shown in FIG. 6A. Web page 600A may display the various tables that are stored in the regulation module. A regulation module user meeting the appropriate access requirements may be provided with functionality to manage the database tables by means of, for example, a “manage” hyperlink associated with each table. Upon clicking on a “manage” hyperlink associated with a particular table (for example—Document Types), a regulation module user may be directed to web page 600B shown in FIG. 6B that provides a listing of each category contained within the selected table. The categories may be implemented, for example, as columns in the selected table. A regulation module user may be provided with functionality to edit 601 or delete 602 a category included in the selected table. Such functionality may be provided by means of, for example, “edit” and “delete” hyperlinks on web page 600B. Upon clicking on the “edit” hyperlink, web page 600C may be displayed. Through web page 600C, a regulation module user may, for example, edit the name of a particular category within the table.

As noted earlier, a regulatory compliance system in accordance with one or more embodiments of the invention comprises a regulation module and one or more compliance modules. Each compliance module provides access to a particular subscription and the regulatory data associated therewith. As described earlier, subscription data stored in the regulation module is partitioned into one or more subscriptions, each subscription being associated with a client entity and being linked to at least a portion of the regulatory data. The portion of the regulatory data that is linked to is associated with one or more regulations included in the client entity's subscription.

Each compliance Module is accessible by one or more compliance module users designated by the associated client entity. Access to the compliance module may be restricted to authorized compliance module users through a user authentication process similar to that described in reference to the regulation module. Access to the regulation module and/or the compliance modules may be controlled using various mechanisms. Users of the regulation module and/or the compliance modules may be temporarily locked out after a specified number of failed log-in attempts. Further, certain regulation module users may be provided with the authorization to de-activate the accounts associated with other regulation module users. Similarly, certain compliance module users may be able to de-activate accounts associated with other compliance module users of the same compliance module.

In accordance with one or more embodiments of the invention, modifications to regulatory data relating to a particular regulation (by way, for example, of the “Edit Regulation” web page described earlier) may be transmitted to each compliance module associated with each client entity having a subscription that is linked to the regulatory data. The modifications may be accessible substantially in real-time by one or more compliance module users of the compliance module. In this manner, modifications to regulatory data are transmitted and accessible substantially in real-time to all client entities associated with subscriptions that are linked to the regulatory data. The modifications may involve the text of the regulation itself or may relate to any of the other data sub-types previously described.

The status of a regulation maybe monitored by a third party and any changes that occur to a regulation (e.g., changes to the text of a regulation) may be conveyed to a regulation module user. The regulation module user having the appropriate level of access may then make the necessary modifications to the regulatory data relating to the regulation in the regulation module and store the modified regulatory data in the regulation module.

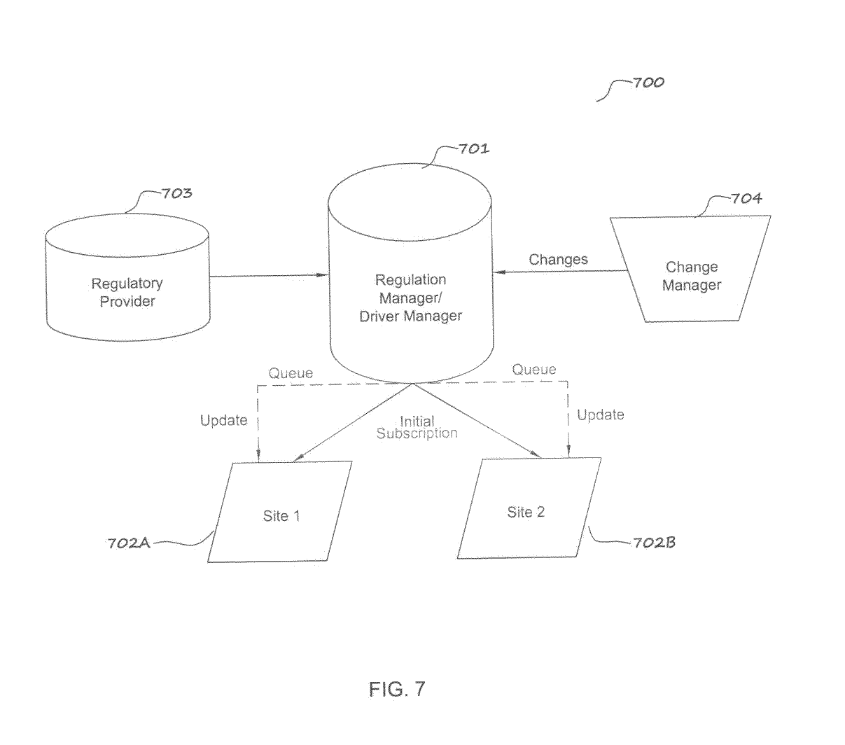

FIG. 7 provides a schematic of the architecture of a regulatory compliance system in accordance with one or more embodiments of the invention. The system 700 comprises a regulation module 701 and compliance modules 702A, 702B. The regulation module 701 may comprise one or more data storage devices that store regulatory data associated with one or more regulations and subscription data partitioned into one or more subscriptions. At least a portion of the regulatory data may be provided by a regulatory provider 703. The regulatory provider 703 may be a third party whose services include monitoring and providing regulatory information. The information provided by the regulatory provider 703 may be input and stored as regulatory data on the data storage devices of the regulation module 701. The regulatory data may be manually input or may be stored on the data storage devices through a fully or partially automated process. The information received from the regulatory provider 702 may be supplemented with information from a regulation module user as it is being entered as regulatory data in the regulation module.

The regulatory provider 703 or another entity may provide information regarding changes or modifications to regulations stored in the regulation module 701. These modifications may be managed by a change manager 704 and input and stored in the regulation module 701 manually or through a wholly or partially automated process. That is, any modifications to a regulation made by the entity that promulgated the regulation, for example, may be input and stored in the regulation module via modifications to the regulatory data that corresponds to the regulation. In addition, users of the regulation module having the appropriate level of access may modify aspects of the regulatory data Any modifications made to regulatory data are conveyed to the compliance modules 702A, 702B that provide access to subscriptions that are linked to the regulatory data that has been modified. Users of the compliance modules 702A, 702B are provided with functionality to accept, reject, or delay a decision with respect to each modification that is made. This functionality and the manner in which it is implemented at a user level and at a back-end implementation level will be described in greater detail hereinafter.

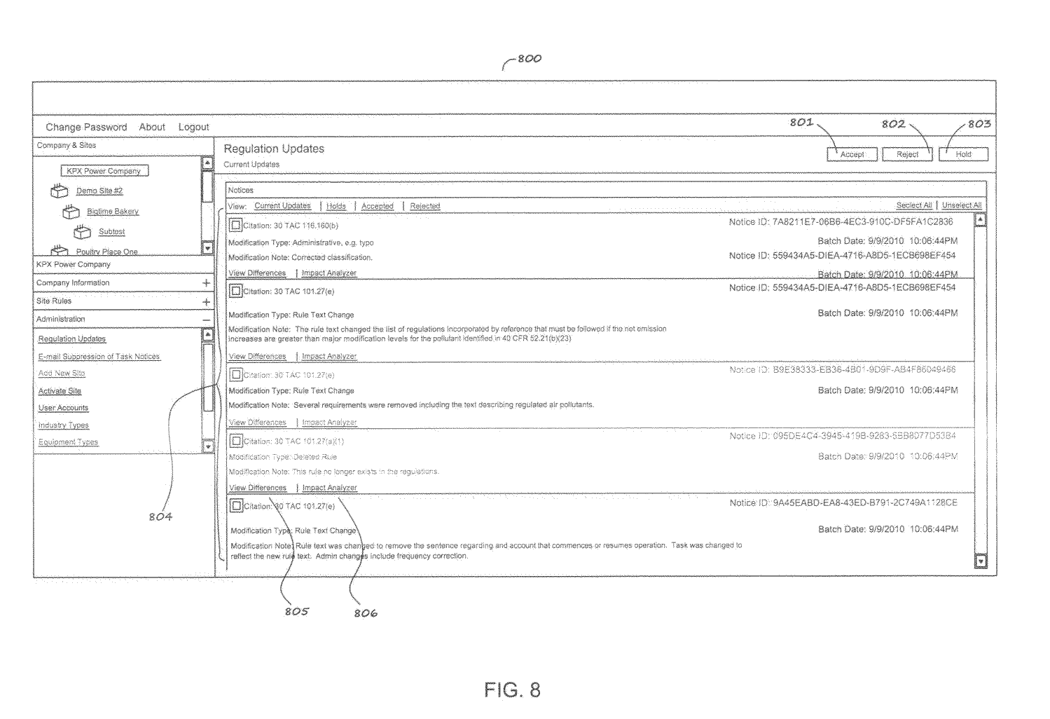

FIG. 8 depicts compliance module functionality for viewing modifications to regulatory data in accordance with one or more embodiments of the invention. The functionality may be implemented by means of, for example, a web page 800 that displays a listing 804 that identifies those regulations included in a client's subscription that are associated with regulatory data that has been modified in some manner. If the regulatory data relating to a regulation that forms part of a client's subscription is modified, various information relating to the modification may be presented to a compliance module user via the “regulation updates” listing 804. The information may include citation information that identifies the particular regulation whose associated regulatory data has been modified. The information may also include a description of the type of the modification that was made to the regulatory data associated with the regulation and a modification note that may represent a user-inputted description of the modification. The modification type may be a broadly defined description of the modification and may be manually entered by a regulation module user or selected from one or more pre-defined modification types. The modification note may be a more detailed description of the nature of the modification that was made.

In connection with each regulation included in the listing 804 and the associated information relating to the nature of the modification(s) made to the regulatory data that corresponds to the regulation, the compliance module user may be provided with functionality 805 that allows the user to compare the modified regulatory data to a previous version of the regulatory data (implemented by means of “View Differences” hyperlink in web page 800) and with functionality 806 that allows the user to analyze an effect of the modifications to the regulatory data on the client's operations (implemented by means of an “impact Analyzer” hyperlink in web page 800).

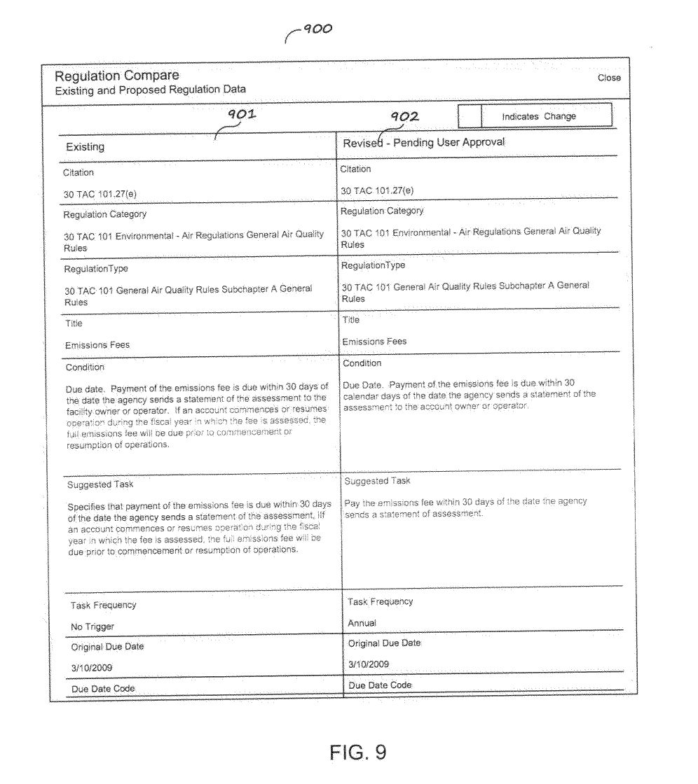

Referring to FIGS. 8 and 9, upon clicking on the “View Differences” hyperlink on web page 800, a compliance module user may be directed to web page 900 (FIG. 9) that provides a convenient and user-friendly presentation of content for allowing the user to determine which regulatory data sub-types have been modified. The web page 900 shown in FIG. 9 displays in column 901 the regulatory data to which the subscription is currently linked. In column 902, the web page 900 displays the modified regulatory data which includes those particular data sub-types that have been modified. The modified data sub-types are clearly delineated to the user. In the example web page 900 shown in FIG. 9, a color-coded scheme may be used to easily identify which data sub-types have been modified. However, it should be noted that any indicator may be used for identifying the modifications that have been made. In the exemplary regulatory data comparison shown in FIG. 9, the suggested task and condition data sub-types have been modified.

Although regulatory data may be modified via the regulation module, previous versions of the regulatory data continue to be stored in the regulation module. Referring again to FIG. 8, a compliance module user may be provided with functionality that allows the user to accept 801, reject 802, or hold 803 a modification that has been made to regulatory data associated with a regulation. This functionality may be available to the compliance module user by means of, for example, accept, reject, and hold buttons positioned on the web page 800. If the user decides to accept 801 one or more modifications to the regulatory data associated with a particular regulation, the user may check a check-box associated with the regulation and click the accept button. Upon accepting a particular modification to regulatory data associated with a regulation, the link between the Subscription and the regulatory data associated with the regulation will be updated to include a link to the modified regulatory data. Depending on how the regulatory data is organized in the regulation module, in certain embodiments of the invention, the link between the subscription and the un-modified regulatory data may be maintained and only the link to those data sub-types that have been modified may be replaced with a link to the modified regulatory data sub-types. In other embodiments of the invention, upon accepting one or more modifications that have been made to regulatory data associated with a regulation, the entire link between the subscription and the regulatory data may be replaced with a link to the modified regulatory data.

In one or more other embodiments of the invention, the portion of the regulatory data corresponding to a subscription may be stored in the compliance module that provides access to that subscription. In these embodiments, the link referred to above may be a link between the subscription and the corresponding portion of the regulatory that has been stored in the compliance module. As such, when a compliance module user decides to accept a modification to regulatory data, the regulatory data which is stored in the compliance module and which is linked to the subscription may be updated/modified to reflect the modifications made to the corresponding regulatory data stored in the regulation module.

If the compliance module user decides to reject 802 one or more modifications to the regulatory data corresponding to a regulation, the link between subscription and the regulatory data will remained unchanged. That is, the subscription will continue to be linked to the previous version of the regulatory data stored in the regulation module rather than the modified regulatory data. Alternately, in one or more embodiments, if a user decides to reject a modification, the subscription will remained linked to the current version of the regulatory data stored in the compliance module.

In addition, a compliance module user may be provided with functionality that allows the user to hold 803 one or more modifications to regulatory data corresponding to a regulation. If a compliance module user decides to hold 803 a modification to regulatory data, the user is provided with the capability to accept or reject the modification at a later time.

A client may decide to reject 802 one or more modifications to regulatory data in those scenarios, for example, where the modification does not apply to the substantive text of the regulation, but rather changes other data sub-types associated with the regulation (e.g. the task frequency). Any of the data sub-types associated with a regulation may be modified. For example, a suggested task associated with the regulation may be changed.

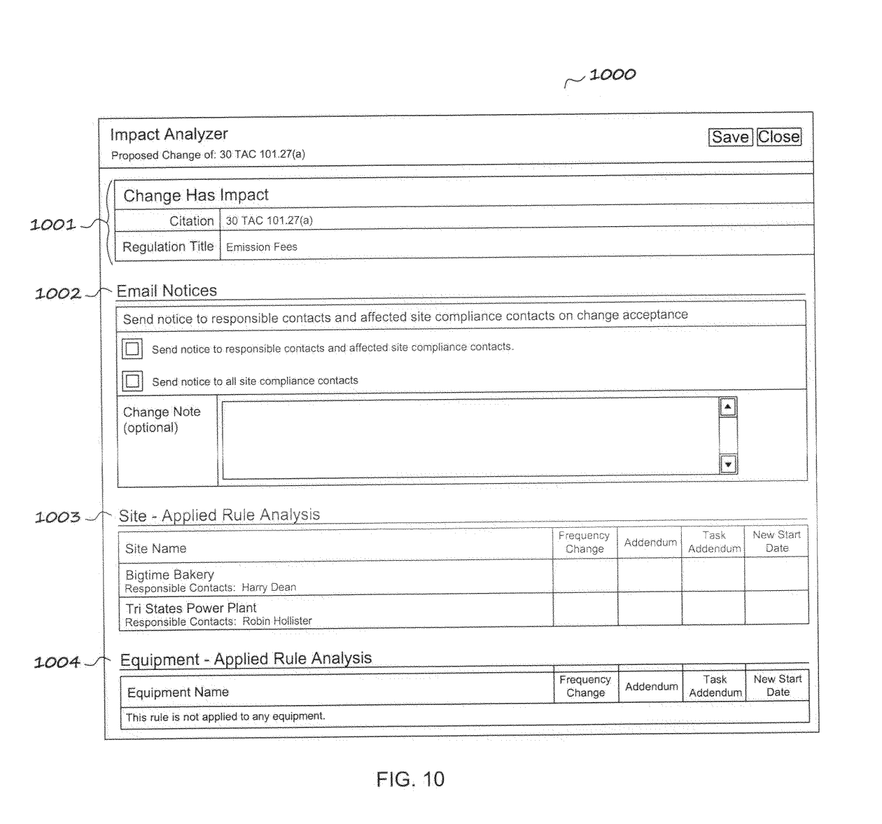

In addition, as noted earlier, a compliance module user may be provided with functionality that allows the user to view and analyze an impact that one or more modifications to regulatory data may have on its operations. For example, from web page 800, a compliance module user maybe able to click on an “Impact Analyzer” hyperlink that directs the user to web page 1000 (FIG. 10) that provides the user with various information relating to the regulation whose corresponding regulatory data has been modified. For example, information 1003 relating to the application of the regulation to one or more sites and information 1004 relating to the application of the regulation to one or more pieces of equipment may be displayed. Application of a regulation to a particular site or piece of equipment will be described in greater detail later.

The web page 1000 may display various information fields relating to a regulation, and indicate whether the modifications to the regulatory data pertain to the information fields. For instance, the web page 1000 may generally indicate in information field 1001 whether the modifications to the regulatory data impact the client's operations. Whether a modification impacts a client's operations may be determined, for example, based on whether the regulation has been applied to a site and/or a piece of equipment.

The web page 1000 may also provide a compliance module user with functionality to send notices relating to the modifications to one or more individuals through field 1002. Each site may have a “responsible contact” associated therewith as well as one or more “compliance contacts” associated therewith. The responsible contact may be tasked with managing the overall operations of one or more sites. Compliance contacts may be designated for each site and may be tasked with ensuring overall regulatory compliance of that particular site or compliance with a subset of regulations that have been applied to that site. Depending on the nature of the modifications made to the regulatory data, a compliance module user may send a notice to the responsible contacts as well as the compliance contacts at the sites affected by the modifications. If the modifications are determined to be relevant to other sites beyond those to which the regulation has been applied, the compliance module user may send a notice to all site compliance contacts. The notice may, for example, include a description of the nature of the modifications and suggested actions to be taken in response to the modifications. For example, if the modifications relate to a lowering of the emission limit of a particular compound during a manufacturing process, the notice may suggest a course of action for testing, monitoring, and potentially modifying aspects of the manufacturing process to ensure compliance with the new emission limit.

Information fields 1003 and 1004 provide information with respect to each site and piece or equipment, respectively, to which the regulation has been applied. A compliance module user may use information fields 1003 and 1004 to assess the extent of the impact a modification to the regulatory data associated with a regulation may have on the client's operations. The fields displayed in FIG. 10 are not limited to those explicitly described and may include additional fields relevant to a modification to regulatory data.

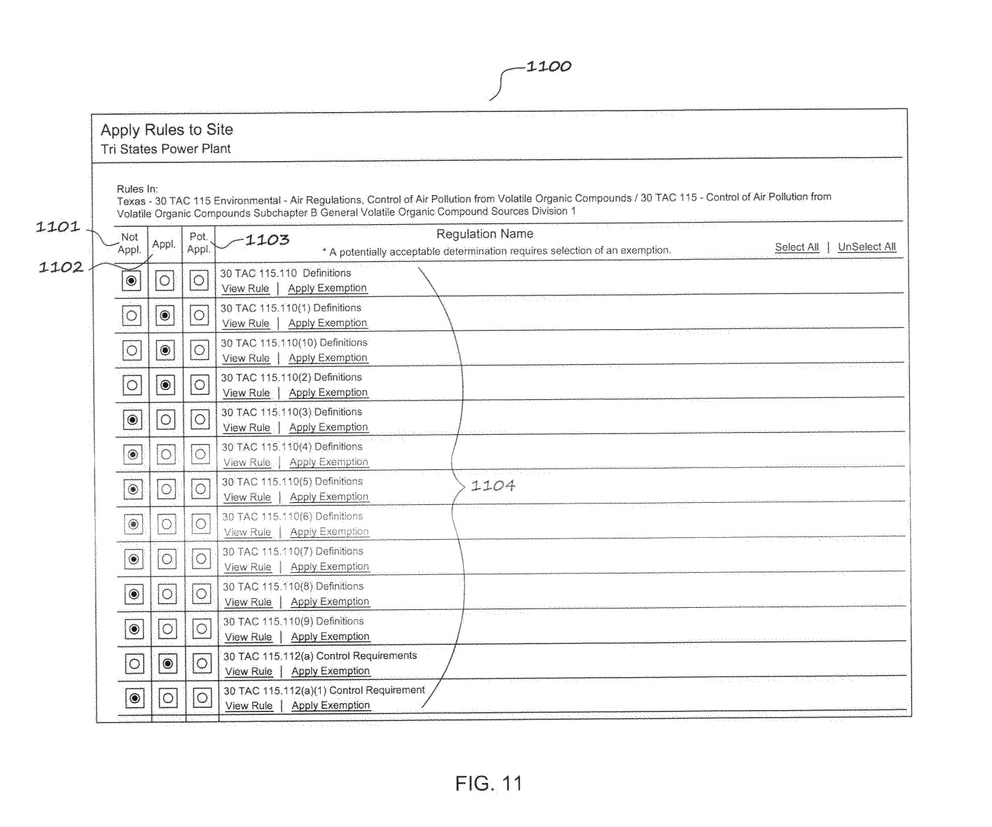

FIG. 11 depicts compliance module functionality for determining and designating applicability of a regulation to a particular client site. The functionality may be provided to a compliance module user by means of, for example, web page 1100. Web page 1100 may display new or proposed regulations which may include regulations that have been newly promulgated and/or regulations that have been proposed for rulemaking. Web page 1100 may also display regulations already included in a client's subscription that have not been associated with (applied to) a particular client site. Web page 1100 may also display various information relating to a client's subscription such as news items (not shown) discussing issues relevant to a client's industry such as potential changes to one or more regulations included in the client's subscription. The news items maybe filtered so that only those news items relating to a particular site or piece of equipment are conveyed to the compliance module users.

The web page 1100 may provide a compliance module user with functionality allowing the user to make a determination as to whether a particular regulation is applicable to a particular site. As used herein, a site may refer to one of several locations of a particular company or organization. For example, if a client company owns and operates several manufacturing plants throughout the United States, each plant may be considered a separate site. A compliance module user may be provided with a listing 1104 of regulation citations relating to regulations which may already be included in a client's subscription and which may, for example, be associated with other client sites, and/or citations of regulations that may not currently be included in a client's subscription. A compliance module user may be provided with functionality to view the text of a regulation by means of, for example, a “View Rule” hyperlink. If a regulation is applied to a particular site, the regulation will be associated with that site and viewable through the compliance module in connection with that site.

The web page 1100 may provide a user with the capability to designate a particular regulation as applicable 1102, not applicable 1101, or potentially applicable 1103 to a particular site. A compliance module user may determine that a particular regulation is potentially applicable 1103 to a particular site in a scenario where the regulation is not currently applicable to the site, but may become applicable at a future date depending on the nature of the operations at that site. A compliance module user having the appropriate understanding of the operations conducted at a particular site (for example a compliance contact associated with the site) may be tasked with the responsibility of assessing the potential applicability of regulations to that site. In determining that a particular regulation is not applicable or potentially applicable to a site, the user may be required to provide an exemption reason detailing the reason why the regulation is not currently applicable. This functionality may be provided to the user by means of, for example, an “Apply Exemption” hyperlink that when clicked on allows the user to input text describing the reason the site is exempt from the rule or, in the alternative, select from a list of predefined exemption reasons.

Web page 1100 depicts an exemplary interface for providing a compliance module user with functionality to determine applicability of a regulation and designate the regulation as applicable, not applicable, or potentially applicable to a particular site. It should be noted that embodiments of the invention are not limited to the particular interface and organization of content shown in FIG. 11 and other interfaces or content organizations are within the scope of the invention. Similar functionality may be provided to a compliance module user for assessing and designating the applicability of one or more regulations to particular piece of equipment.

In accordance with one or more embodiments of the invention, the regulatory data associated with each regulation may be assigned a first identifier that may be used to link the regulatory data to each subscription that includes the regulation. That is, each subscription that is linked to the regulatory data associated with a regulation may be linked via the first identifier. In the event that a particular regulation is applied to a particular site or piece of equipment, the regulatory data associated with that regulation may be assigned a second identifier that is unique to the subscription that is associated with the client entity that comprises the site. In one or more embodiments of the invention, the first identifier may be associated with regulatory data stored in the regulation module and the second identifier may be associated with regulatory data that is stored in a compliance module.

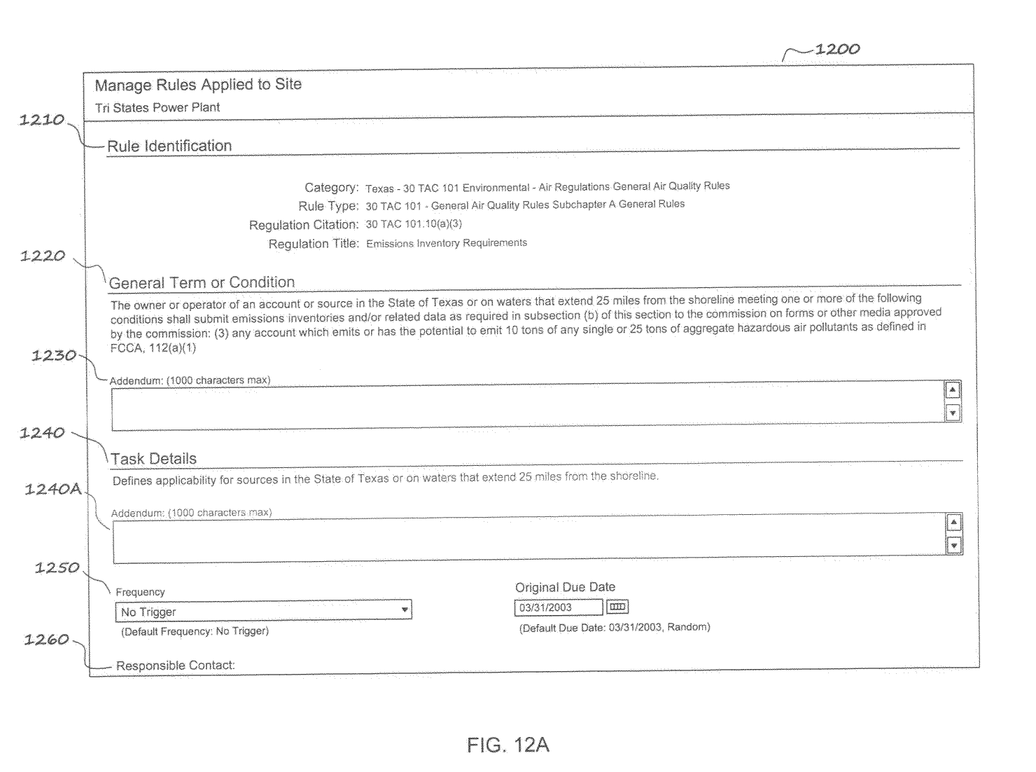

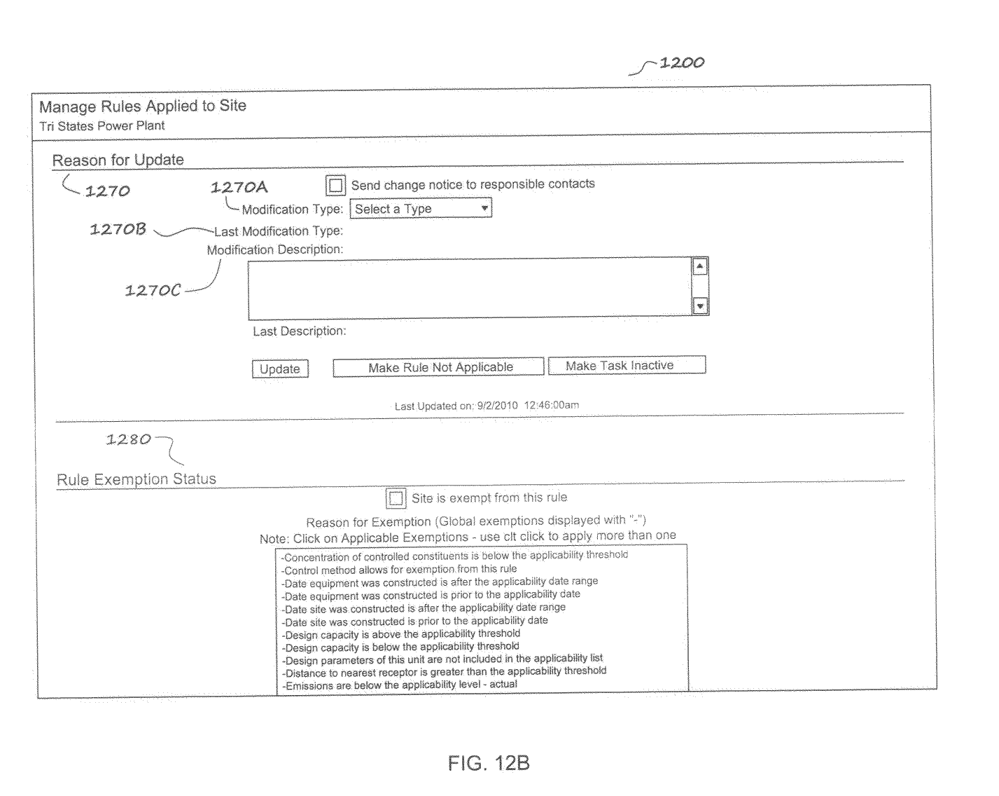

As will be described in more detail through reference, for example, to FIGS. 12A-12B, a compliance module user may be provided with the capability to generate compliance data that is associated with one or more regulations included in a client's subscription. The compliance data may comprise modifications made to various regulatory data sub-types associated with a regulation from the client side (i.e. through the compliance module). These modifications may comprise, for example, modifications to the task: and task frequency associated with a particular regulation, addendums to the text of the regulation and/or the task, and so on. These modifications to the regulatory data associated with a particular subscription that are made through an associated compliance module differ from modifications made to regulatory data through the regulation module as they are unique to the particular compliance module, subscription, and client entity to which they relate. As such, the second identifier assigned to regulatory data relating to a regulation that has been applied to a site or piece of equipment may be used to link the regulatory data stored in the regulation module with the compliance data that includes any client-side modifications to the regulatory data. Alternately, in one or more embodiments of the invention, the regulatory data associated with a client's subscription may be additionally stored in the compliance module associated with the client and the second identifier may be used to link the regulatory data stored in the compliance module with the corresponding compliance data. The second identifier may optionally also be used to link compliance data and regulatory data stored in the compliance module with a corresponding subscription. The compliance data may be stored on one or more data storage devices included in the compliance module.

FIGS. 12A-12B depict compliance module functionality for managing regulatory data and generating compliance data relating to a regulation that has been applied to a particular site in accordance with one or more embodiments of the invention. The functionality may be provided to a compliance module user by means of, for example, a web page 1200 that displays regulatory data relating to a regulation that has been applied to a site. The displayed regulatory data may comprise rule identifying data 1210, text or condition data 1220, task data 1240, task frequency data 1250, responsible contact data 1260, modification data 1270, and rule exemption data 1280.

The rule identifying data 1210 comprises several of the regulatory data sub-types previously described such as the regulation category, regulation type, regulation citation, and regulation title. These are generally not capable of being modified through the compliance module. The text or condition data 1220 comprises, as previously described, the exact text of the regulation or a paraphrased summary. A compliance module user may be provided with functionality that allows client-side customization of the text or condition data. That is, authorized compliance module users may be provided the capability to modify the text data by, for example, including an addendum 1230 to the regulation condition. The addendum 1230 may include, for example, a compliance module user's analysis of the effect or impact of the regulation on the operations of the site. Alternately, if the text of the regulation is particularly complex, the addendum may provide a synopsis of the regulation text that is more comprehensible.

The regulatory data displayed on web page 1200 may further comprise task data 1240. The task data 1240 may comprise a suggested course of action to be taken with respect to the regulation. Similarly to the text data 1220, the task data 1240 may include an addendum field 1240A, that allows a compliance module user to input additional information relating to the suggested task. For example, if the suggested task data in the regulatory data stored in the regulation module provides for quality control assessments every quarter and a compliance module user more familiar with the-site operations deems that the suggested frequency of such assessments is unnecessary, then the user may include an addendum 1240A that recommends deviating from the suggested task data stored in the regulation module.

A compliance module user may also be provided with the capability to set or alter the task frequency via field 1250. As such, a compliance module user more familiar with site operations may adjust the task frequency data stored in the regulation module. In addition, the regulatory data associated with the regulation and displayed through web page 1200 may include responsible contact data 1260. A compliance module user meeting the appropriate access requirements may be provided with the capability to modify the responsible contact data 1260 to, for example, include additional contacts or remove contacts.

Referring now to FIG. 12B, web page 1200 may also display modification data 1270. The modification data 1270 may comprise modification type data 1270A, an indicator 1270B of the last modification that was made, and a description 1270C of the nature of the modification. For example, if the compliance module user included an addendum to the text data 1230, the user may specify the modification type 1270A as an addendum to the text data and may provide a brief description of the addendum in the modification description 1270C. A compliance module user may also be provided with the capability to make a regulation no longer applicable to the site and the capability to inactivate a task if the user deems that the regulation is no longer pertinent to the site and/or it is no longer necessary to perform the suggested task with respect to the regulation.

Rule exemption data 1280 may also be displayed via web page 1200. A compliance module user may be provided functionality that allows the user to indicate that the site is exempt from the regulation and to select one or more exemption reasons.

As previously discussed, the regulatory data associated with a regulation is assigned a first identifier that may be used to link the regulatory data to each subscription that includes the regulation. In addition, when a regulation is applied to a particular site or piece of equipment, the regulatory data associated with that regulation may be assigned a second identifier that is unique to the subscription associated with the client entity that includes the site. A compliance module user meeting the appropriate access requirements may be provided with the capability to edit the regulatory data associated with a regulation through the compliance module to generate compliance data that is stored in the compliance module. The compliance data may also comprise any compliance reports generated with respect to a client entity's compliance with one or more regulations included in its subscription. The compliance data associated with a regulation may be linked to the regulatory data associated with the regulation via the second identifier. The regulatory data may be stored in the regulation module and/or one or more compliance modules providing access to subscriptions linked to the regulatory data.

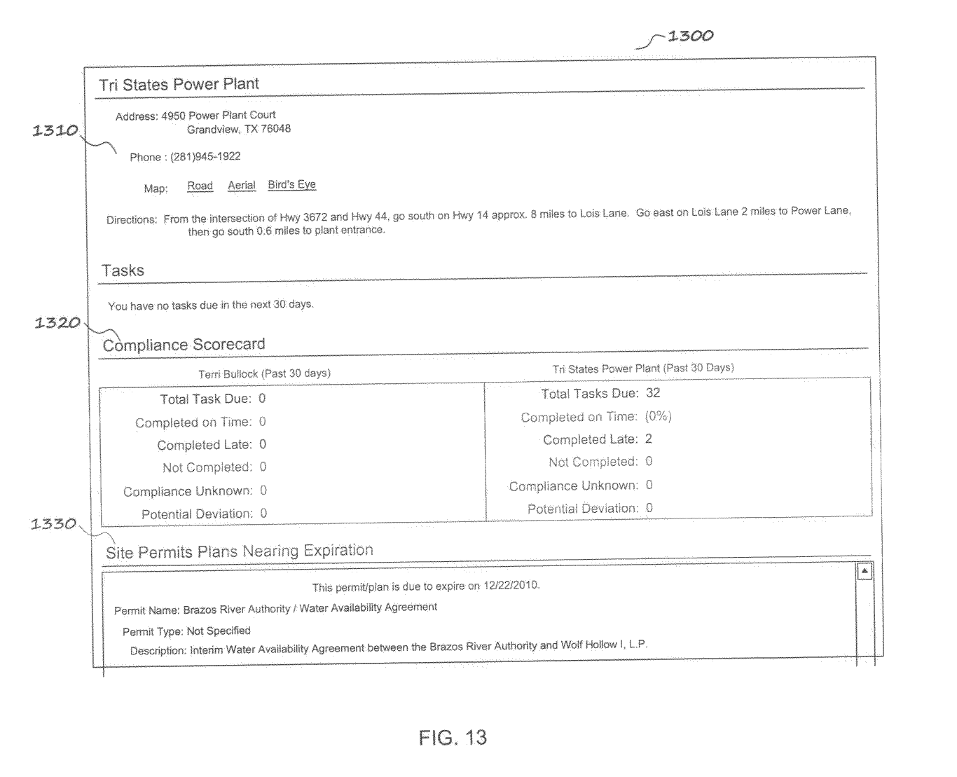

FIG. 13 depicts compliance module functionality for displaying and managing site regulatory compliance in accordance with one or more embodiments of the invention. The functionality may be provided, to a compliance module user by means of, for example, web page 1300 that provides a compliance module user with various information relevant to a particular site. The information may include various identifying information 1310 relating to the site (address, phone, directions, etc.) as well as a compliance scorecard 1320. The compliance scorecard 1320 provides an assessment of the task completion rate of various compliance contacts associated with the site, and an overall assessment of the task compliance of the site including information regarding the number of tasks completed on schedule, the number of tasks completed late, and the number of outstanding tasks. Also provided may be information 1330 relating to any permits that are associated with the site including any permits that may be nearing expiration.

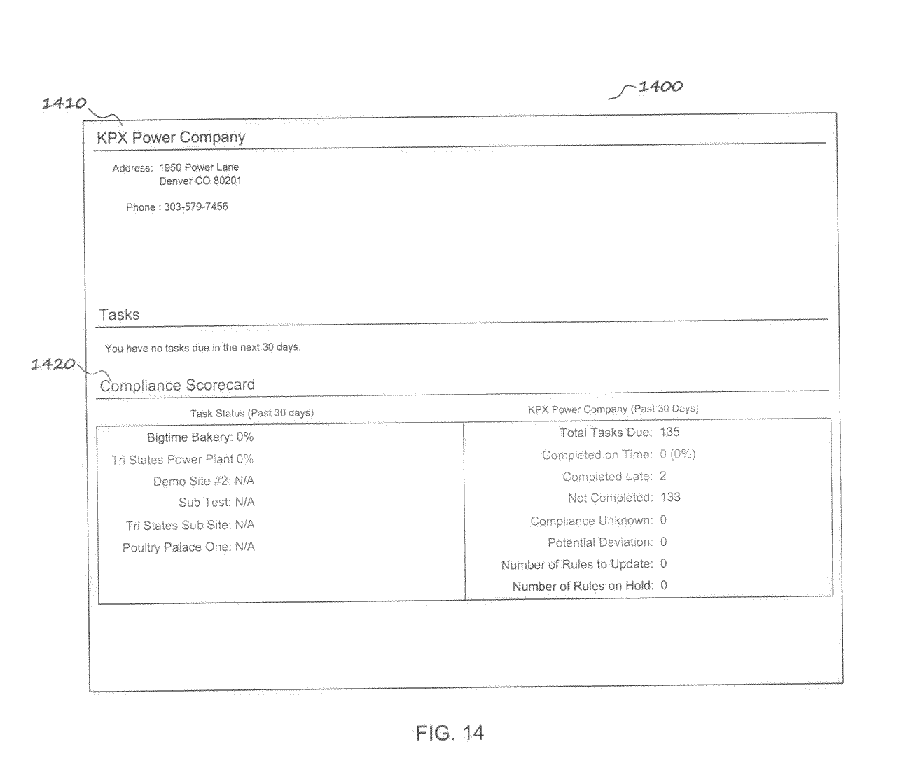

FIG. 14 depicts compliance module functionality for displaying and managing regulatory compliance with respect to a client's overall operations in accordance with one or more embodiments of the invention. The functionality may be implemented by means of, for example, web page 1400 that provides information relating to the regulatory compliance of a client entity as a whole including all sites associated with the client. The information may include identifying information 1410 for the client as well as a compliance scorecard 1420 for the client entity as a whole. The compliance scorecard 1420 may indicate a task completion rate for each of the client sites as well as information relating to a number of outstanding tasks across all sites, a number of tasks completed on schedule across all sites, and a number of tasks completed late across all sites. The information displayed by web page 1400 provides a compliance module user with an overview of site-wide regulatory compliance as opposed to web page 1300 which provides an assessment of regulatory compliance with respect to a particular site.

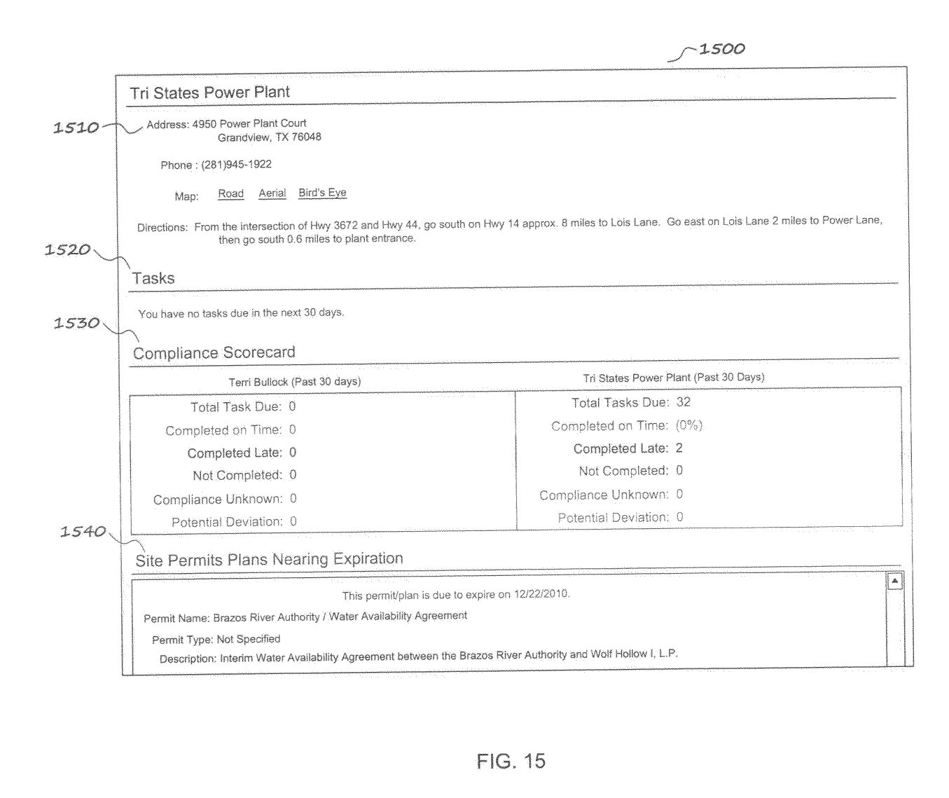

FIG. 15 depicts compliance module functionality for viewing and assessing regulatory compliance of a particular compliance contact associated with a site. The functionality may be provided by means of, for example, a web page 1500 which displays various identifying information 1510 for the site with which the responsible person is associated, information 1520 detailing tasks that the responsible person must complete, a compliance scorecard 1530 for the responsible person that is similar to the compliance scorecards previously described, and information 1540 relating to any permits that are associated with the site managed by the responsible person.

It should be noted that embodiments of the invention are not limited to the particular data sub-types or categories or fields of information discussed above. Additional data sub-types and categories of information may be stored, retrieved, displayed, and manipulated on any of the web pages described herein and alternate or additional forms of information may be provided to a user. In addition, embodiments of the invention are not limited to the means for implementing and providing the system functionality described above. Numerous types of user interfaces and means for organizing and presenting information to a regulation module user and/or a compliance module user are within the scope of the invention.

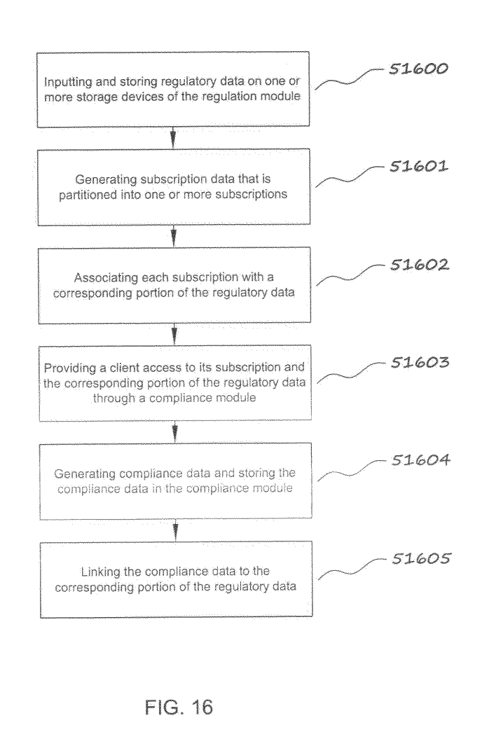

FIG. 16 depicts a flowchart of a method for facilitating regulatory compliance in accordance with one or more embodiments of the invention. The method comprises, in step S1600, inputting and storing regulatory data on one or more data storage devices of the regulation module. The regulatory data may include any of the data sub-types previously described and may be manually input to the regulation module or may be input and stored via a process that is at least partially automated. At least some of the regulatory data may be provided by an external data provider.

In step S1601, subscription data is generated and partitioned into one or more subscriptions. As used herein, a subscription may refer to the particular grouping of regulations that a client entity has chosen to monitor as well as any data relating to that grouping of regulations and/or the client entity. If a new client entity desires to acquire a subscription to manage and track a set of regulations, then subscription data may be generated and partitioned as a subscription for that client.

In step S1602, each subscription is associated or linked with a corresponding portion of the regulatory data. For instance, each subscription maybe linked to the regulatory data that relates to those regulations that are included in the subscription and that a client entity seeks to monitor.

In step S1603, a client entity is provided with access to its subscription and the corresponding regulatory data through a compliance module. In one or more embodiments of the invention the method may optionally include a step of storing the corresponding regulatory data in the compliance module and providing a Link to between the subscription data and the corresponding regulatory data stored in the compliance module.

In step S1604, one or more authorized compliance module users may be provided with functionality through the compliance module to generate compliance data which may comprise client-side modifications to the regulatory data associated with the client's subscription. The compliance data may be stored on one or more data storage devices included in the compliance module.

In step S1605, any compliance data that is generated may be linked to the regulatory data to which it pertains. In this manner, any modifications made to the regulatory data on the client-side are linked to the corresponding regulatory data which may be stored in the regulation module and/or the compliance module.

In one or more embodiments of the invention, additional steps may be included in the process flow depicted in FIG. 16 to implement any of the system functionality previously described.

A compliance module user may also be provided with additional functionality beyond that which has been previously described. For example, a compliance module user may be able to apply regulations to a particular site in accordance with a template created based on another site. More specifically, the compliance module user may be able to quickly apply a set of regulations to a particular site based on similarities between the site and another site to which the regulations have already been applied.

In addition, the regulation module may include profiles that are associated with a particular type of industry or a particular process (e.g. a manufacturing process). These profiles may be linked or associated with certain regulations that commonly affect the type of industry or activity corresponding to the profile. A client may choose to associate its subscription with one or more profiles and thus more efficiently incorporate those regulations associated with these profiles in its subscription.

The terms compliance module user and regulation module user have been used throughout this disclosure to designate an authorized user associated with a client entity provided access to regulatory data through the compliance module and an authorized user of the regulation module, respectively. Regulation module users are entities (individuals, organizations, etc.) provided with varying hierarchical levels of access to the regulation module to perform various functions such as accessing and/or modifying regulatory data and/or subscription data. A compliance module user is an entity designated by and associated with a client entity that is provided with the authorization to access the client entity's subscription data (and the linked regulatory data) through the associated compliance module. A compliance module user may correspond, for example, to an employee or representative of a client associated with a subscription. A user of the compliance module generally does not have access to the regulation module.

In certain embodiments of the invention, a regulatory compliance service entity and a restricted number of authorized users associated with the entity may manage and modify regulatory data stored in the regulation module. In other embodiments of the invention, a forum may be provided by the regulatory compliance service entity in which third parties may input data relating to one or more regulations. For example, the regulatory compliance service entity may provide, varying levels of access for third parties to the forum. Some third parties, for example, may be provided with the capability to input modifications to one or more data sub-types associated with a regulation such as modifications relating to the text or summary of the regulation. Other third parties may be provided solely with the capability to submit notices with respect to regulations. An exemplary notice may include information provided by a third party that details issues encountered by that third party with respect to compliance with a particular regulation or set of regulations. For example, if a particular third party was forced to pay a substantial fine as a result of failing to properly interpret a regulatory provision, that third party may submit a notice in connection with that regulation in the forum. This notice may then be transmitted to one or more client entities whose subscriptions include the relevant regulation based on settings designated by the client entities. In this manner, for example, clients may cooperatively assist one another in ensuring regulatory compliance.

What is claimed is:

1. A regulatory compliance system comprising:
a regulation module comprising:
regulatory data relating to one or more regulations, and
subscription data partitioned into one or more subscriptions, each of the subscriptions being associated with a client entity,
each of the subscriptions being linked to a corresponding portion of the regulatory data relating to at least one of the regulations;
the regulatory compliance system further comprising:
one or more compliance modules through which the subscription data and the regulatory data are accessible, each compliance module being associated with a client entity and providing access to a subscription associated with the client entity and the corresponding portion of the regulatory data.

2. The regulatory compliance system of claim 1, wherein:
access to the regulation module is restricted to one or more regulation module users, and
for each of the compliance modules, access to the compliance module is restricted to one or more compliance module users designated by the client entity associated with the compliance module.

3. The regulatory compliance system of claim 2, the regulation module comprising:
one or more data storage devices storing the regulatory data and the subscription data, and
each of the compliance modules comprising one or more data storage devices storing compliance data, the compliance data relating to the subscription associated with the client entity that is associated with the compliance module.

4. The regulatory compliance system of claim 3, the regulation module comprising:
at least one of a search function and a browse function,
the search function providing the one or more regulation module users with the capability to retrieve regulatory data relating to at least one regulation based on one or more search criteria,
the browse function providing the one or more regulation module users with the capability to retrieve regulatory data relating to at least one regulation based on one or more regulation identifiers.

5. The regulatory compliance system of claim 3, the regulatory data relating to the one or more regulations comprising at least one data sub-type for each of the regulations, the at least one data sub-type comprising at least one of:
modification data;
categorization data;
classification data;
date data;
text data; and
task data.

6. The regulatory compliance system of claim 5, the regulation module further comprising:
an edit function that provides at least one of the regulation module users with the capability to modify at least one data sub-type of at least one regulation.

7. The regulatory compliance system of claim 5, the regulation module further comprising:
an add function that provides at least one of the regulation module users with the capability to specify and store on the one or more data storage devices of the regulation module regulatory data relating to an additional regulation, the regulatory data comprising at least one of the data sub-types.

8. The regulatory compliance system of claim 6, wherein on the condition that one or more modifications are made to original regulatory data relating to a regulation to generate modified regulatory data, the modified regulatory data being accessible by at least one of the compliance module users through each compliance module associated with each client entity that is associated with a subscription that is linked to the original regulatory data relating to the regulation.

9. The regulatory compliance system of claim 7, wherein on the condition that, based on one or more filtering criteria, a potential correspondence is determined to exist between the regulatory data relating to the additional regulation and a subscription, a notification is sent from the regulation module to the compliance module associated with the client entity associated with the subscription, the notification indicating the potential correspondence.

10. The regulatory compliance system of claim 8, the compliance module comprising:
an analyzer function that provides the at least one of the compliance module users with the capability to compare the original regulatory data relating to the regulation with the modified regulatory data to determine one or more data sub-types to which the one or more modifications pertain.

11. The regulatory compliance system of claim 8, wherein the at least one of the compliance module users associated with each client entity that is associated with a subscription that is linked to the original regulatory data relating to the regulation is provided with the capability to specify at least one action to be taken with respect to the original regulatory data, the at least one action comprising at least one of:
accepting at least one of the modifications,
rejecting at least one of the modifications, and
holding at least one of the modifications,
wherein,
on the condition that at least one of the modifications is accepted, the subscription is updated to replace at least a portion of the link to the original regulatory data with a link to the modified regulatory data,
on the condition that each of the modifications is rejected, the link between the subscription and the original regulatory data is maintained, and
on the condition that at least one of the modifications is held, the at least one of the compliance module users is provided with the capability to accept or reject the at least one held modification as part of an action taken subsequent to the at least one action.

12. The regulatory compliance system of claim 3, wherein at least one client entity comprises one or more sites, each of the one or more sites comprising one or more pieces of equipment, and the one or more compliance module users designated by the at least one client entity comprise at least one compliance module user provided with the capability to associate at least a portion of the corresponding regulatory data to which the subscription associated with the client entity is linked with at least one of: at least one of the sites and at least one of the pieces of equipment.

13. The regulatory compliance system of claim 12, wherein each portion of the regulatory data that relates to one regulation is assigned a first identifier that is used to link the each portion of the regulatory data to each corresponding subscription, and on the condition that a portion of the regulatory data that relates to one regulation is associated with at least one of a site and a piece of equipment of the at least one client entity, the associated portion of the regulatory data is assigned a second identifier that is unique to the at least one client entity.

14. The regulatory compliance system of claim 13, wherein the at least one compliance module user is provided with the capability to generate compliance data, the compliance data being stored on the compliance module associated with the at least one client entity and being linked to the associated portion of the regulatory data by means of the second identifier.

15. The regulatory compliance system of claim 14, wherein the compliance data comprises at least one modification to the associated portion of the regulatory data, the at least: one modification relating to at least one data sub-type of the associated portion of the regulatory data.

16. The regulatory compliance system of claim 14, wherein the compliance data comprises at least one of: data indicating whether the one regulation is associated with a site, and data indicating whether the one regulation is associated with a piece of equipment,
wherein the at least one compliance module user is provided with the capability to send a notice relating to the one regulation to one or more individuals associated with at least one of the sites.

17. The regulatory compliance system of claim 2, wherein each of the regulation module users is provided with a hierarchal level of access to the regulation module and at least one of the regulation module users is provided with the capability to generate a notice relating to a regulation, the notice being accessible by at least one compliance module user designated by each client entity that is associated with a subscription that is linked to the regulatory data that relates to the regulation, the notice being accessible through the compliance module associated with the client entity based on settings determinable by the client entity.

18. The regulatory compliance system of claim 14, wherein the compliance data comprises a compliance scorecard, the compliance scorecard indicating a degree of compliance with one or more tasks specified by the associated portion of the regulatory data.

19. A method for regulatory compliance, the method comprising:
inputting and storing regulatory data relating to one or more regulations on one or more data storage devices;
generating subscription data, the subscription data being stored on the one or more data storage devices and being partitioned into one or more subscriptions, each of the subscriptions being associated with a client entity and being linked to a corresponding portion of the regulatory data relating to at least one of the regulations; and
providing each client entity with access to an associated subscription through an associated compliance module.

20. A computer-readable medium storing a computer program for regulatory compliance, the computer program comprising instructions for:
generating subscription data, the subscription data being stored on one or more data storage devices and being partitioned into one or more subscriptions, each of the subscriptions being associated with a client entity and being linked to a corresponding portion of regulatory data relating to at least one of one or more regulations, the regulatory data being stored on the one or more data storage devices; and
providing each client entity with access to an associated subscription through an associated compliance module.

21. The method of claim 19, further comprising:
generating compliance data through the associated compliance module, the compliance data comprising at least one modification to the corresponding portion of the regulatory data;
storing the compliance data on one or more data storage devices of the compliance module; and
linking the compliance data to the corresponding portion of the regulatory data.

22. The method of claim 21, further comprising:
assigning a first identifier to the corresponding portion of the regulatory data;
linking the subscription to the corresponding portion of the regulatory data via the first identifier;
assigning a second identifier to the corresponding portion of the regulatory data; and
linking the compliance data to the corresponding portion of the regulatory data via the second identifier.
